(19) United States
(12) Patent Application Publication
(10) Pub. No.: US 2023/0269023 A1
(43) Pub. Date: Aug. 24, 2023

(54) RADIO CHANNEL DATA PROCESSING METHOD, COMMUNICATION APPARATUS, AND COMMUNICATION DEVICE

(71) Applicant: HUAWEI TECHNOLOGIES CO., LTD., Shenzhen (CN)

(72) Inventors: Jiahui Li, Shenzhen (CN); Min Yan, Shenzhen (CN); Mengyao Ma, Shenzhen (CN); Wei Lin, Shenzhen (CN); Xun Yang, Shenzhen (CN); Jianmin Lu, Shenzhen (CN)

(21) Appl. No.: 18/310,346

(22) Filed: May 1, 2023

Related U.S. Application Data
(63) Continuation of application No. PCT/CN2021/125644, filed on Oct. 22, 2021.

(30) Foreign Application Priority Data
Nov. 5, 2020 (CN) 202011222058.2

(51) Int. Cl. H04L 1/00

(52) U.S. Cl. CPC H04L 1/0003; H04L 1/0026

(57) ABSTRACT

Embodiments of this application provide a radio channel data processing method, a communication apparatus, and a related device. In the method, a first communication device may send an uplink resource request message to a second communication device. The uplink resource request message includes source distribution information and a first modulation and coding scheme determined based on the source distribution information. The first communication device receives an uplink resource allocation message from the second communication device. The uplink resource allocation message includes a modulation and coding scheme allocated by the second communication device to the first communication device. The first communication device performs modulation and coding on an information bit based on the second modulation and coding scheme. This helps improve coding performance of the first communication device.

### CROSS-REFERENCE TO RELATED APPLICATIONS

This application is a continuation of International Application No. PCT/CN2021/125644, filed on Oct. 22, 2021, which claims priority to Chinese Patent Application No. 202011222058.2, filed on Nov. 5, 2020. The disclosures of the aforementioned applications are hereby incorporated by reference in their entireties.

### TECHNICAL FIELD

This application relates to the field of communication technologies, and in particular, to a radio channel data processing method, a communication apparatus, and a communication device.

### BACKGROUND

Currently, people put forward higher requirements for enjoying multimedia services such as voice, data, image, and video anytime and anywhere. Therefore, the multimedia communication field has become a focus of people's attention. With development of wireless communication, a coding and transmission technology of a multimedia service in a radio channel has become a research hotspot in the multimedia communication field.

Due to a limited bandwidth of the radio channel, multimedia service data needs to be efficiently compressed. However, currently technologies such as predictive coding and variable-length coding applied to a video service make a bit stream very sensitive to a bit error rate of a channel while being used to efficiently compress the video service. Therefore, how to improve coding and decoding performance of a data receive end and a data transmit end in a wireless network becomes a problem to be resolved.

### SUMMARY

Embodiments of this application provide a radio channel data processing method, a communication apparatus, and a communication device. The method helps improve coding and decoding performance of a data receive end and a data transmit end in a wireless network, and improve data transmission reliability.

According to a first aspect, an embodiment of this application provides a radio channel data processing method. The method may be applied to a first communication device. The first communication device may be a transmit end of coded data. Correspondingly, the second communication device is a receive end of the coded data. A data transmission scenario for the first communication device and the second communication device is an uplink data transmission scenario. The first communication device sends an uplink resource request message to the second communication device. The uplink resource request message includes source distribution information and a first modulation and coding scheme. The first modulation and coding scheme is determined based on the source distribution information. The first communication device receives an uplink resource allocation message from the second communication device. The uplink resource allocation message includes a second modulation and coding scheme. The second modulation and coding scheme is a modulation and coding scheme allocated by the second communication device to the first communication device. The first communication device performs modulation and coding on an information bit based on the second modulation and coding scheme.

It can be learned that the first communication device can determine the first modulation and coding scheme based on the source distribution information. This helps improve coding performance of the transmit end of the coded data. The second modulation and coding scheme received by the first communication device may be the same as or different from the first modulation and coding scheme determined by the first communication device.

In an embodiment, the first communication device can obtain a plurality of source distribution quantization intervals in advance. The first communication device determines, for one source distribution quantization interval in the plurality of source distribution quantization intervals, a channel state quantization interval and a modulation and coding scheme corresponding to the source distribution quantization interval. The source distribution quantization interval corresponds to one or more channel state quantization intervals, the source distribution quantization interval corresponds to one or more modulation and coding schemes, and one channel state quantization interval corresponds to one modulation and coding scheme.

It can be learned that the first communication device can quantize source distribution into the plurality of source distribution quantization intervals, and there is a specific correspondence between each source distribution quantization interval, the channel state quantization interval, and the modulation and coding scheme.

In an embodiment, the first communication device determines a corresponding source distribution quantization interval based on a source distribution probability or a source entropy, and determines a corresponding channel state quantization interval based on a preset signal-to-noise ratio working point. The first communication device determines a corresponding channel coding matrix and modulation order based on the corresponding source distribution quantization interval and the corresponding channel state quantization interval.

It can be learned that when determining the source distribution information, the first communication device can determine the corresponding modulation and coding scheme based on the correspondence. This helps improve coding performance of the transmit end of the coded data.

In an embodiment, the first communication device determines a corresponding channel coding matrix, modulation order, and first code rate based on a source distribution probability or a source entropy and a preset quantity of resources. The first code rate is a code rate of the corresponding channel coding matrix.

It can be learned that the first communication device can determine the first modulation and coding scheme based on the source distribution information and the preset quantity of resources. This helps improve coding performance of the transmit end of the coded data.

In an embodiment, the first communication device determines the modulation order based on a preset signal-to-noise ratio working point, and determines a rate-compatible coding matrix set based on the source distribution probability or the source entropy. The rate-compatible coding matrix set includes one or more coding matrices, and one coding matrix corresponds to one code rate. The first communication device determines the first code rate based on the preset quantity of resources, the modulation order, and a source bit rate, and determines, from the rate-compatible coding matrix set based on the first code rate, a coding matrix corresponding to the first code rate as the corresponding channel coding matrix.

It can be learned that the first communication device can determine the first modulation and coding scheme based on the source distribution and an estimated channel state. This helps improve coding performance of the transmit end of the coded data.

In an embodiment, the first communication device determines a rate-compatible coding matrix set based on the source distribution probability or the source entropy. The rate-compatible coding matrix set includes one or more coding matrices, and one coding matrix corresponds to one code rate. The first communication device determines a first relationship that is satisfied between the preset quantity of resources, the modulation order, the first code rate, and a source bit rate, where the first code rate is the code rate of the channel coding matrix; and determines a second relationship that is satisfied between the first code rate and a second code rate. The second code rate is a maximum code rate of a coding matrix indicated by the source distribution information. The first communication device determines the modulation order based on the first relationship and the second relationship, determines the first code rate based on the modulation order and the first relationship, and determines, from the rate-compatible coding matrix set, a corresponding coding matrix as the corresponding channel coding matrix based on the first code rate.

It can be learned that the first communication device can determine the first modulation and coding scheme based on the source distribution and the estimated channel state. This helps improve coding performance of the transmit end of the coded data.

In an embodiment, the first communication device receives first feedback information from the second communication device. The first feedback information includes a signal-to-noise ratio of a channel used by the first communication device to send a data stream to the second communication device.

It can be learned that the second communication device can feed back signal-to-noise ratio information of a current channel to the first communication device according to a weak-feedback communication mechanism, so that the first communication device can determine the first modulation and coding scheme based on the source distribution and an actual channel state of the current channel. This helps improve coding performance of the transmit end of the coded data.

In an embodiment, the first communication device receives second feedback information from the second communication device. The second feedback information indicates correct decoding of the second communication device.

It can be learned that the second communication device can feed back the signal-to-noise ratio information of the current channel and a decoding result to the first communication device according to a strong-feedback communication mechanism. This helps improve coding performance of the transmit end of the coded data.

According to a second aspect, an embodiment of this application provides a radio channel data processing method. The method may be applied to a second communication device, and the second communication device is a receive end of coded data. A data transmission scenario for a first communication device and the second communication device is an uplink data transmission scenario. The second communication device receives an uplink resource request message from a first communication device. The uplink resource request message includes source distribution information and a first modulation and coding scheme, and the first modulation and coding scheme is determined based on the source distribution information. The second communication device sends an uplink resource allocation message to the first communication device. The uplink resource allocation message includes a second modulation and coding scheme, and the second modulation and coding scheme is a modulation and coding scheme allocated by the second communication device to the first communication device.

It can be learned that the second communication device can receive the source distribution information and the first modulation and coding scheme that are from the first communication device, and allocate the second modulation and coding scheme to the first communication device. The first modulation and coding scheme and the second modulation and coding scheme may be the same or different, but both may be determined based on the source distribution information. This helps improve coding performance of a transmit end of the coded data.

In an embodiment, the second communication device receives a data stream from the first communication device. The data stream is determined by the first communication device by performing modulation and coding on an information bit based on the second modulation and coding scheme. The second communication device performs demodulation and decoding on the data stream based on the second modulation and coding scheme and the source distribution information.

It can be learned that the second communication device may perform demodulation and decoding based on the second modulation and coding scheme and the source distribution information. This helps improve decoding performance of the receive end of the coded data.

In an embodiment, the second communication device demodulates the data stream based on a modulation order indicated by the second modulation and coding scheme, and obtains the information bit through decoding based on the source distribution information and a channel coding matrix indicated by the second modulation and coding scheme.

It can be learned that the second communication device can add source prior information to a decoding procedure, so that a non-uniform feature of a source can be effectively used. This helps improve decoding performance of the receive end of the coded data.

In an embodiment, the second communication device obtains first information bit soft information and parity bit soft information in the data stream through demodulating, and determines second information bit soft information based on the source distribution information. The second communication device obtains the information bit through decoding based on the second information bit soft information and the parity bit soft information.

It can be learned that the second communication device can add source prior information to a decoding procedure, so that a non-uniform feature of a source can be effectively used. This helps improve decoding performance of the receive end of the coded data.

In an embodiment, the second communication device sends first feedback information to the first communication device. The first feedback information includes a signal-to-noise ratio of a channel used by the first communication device to send a data stream to the second communication device.

It can be learned that the second communication device can feed back signal-to-noise ratio information of a current channel to the first communication device according to a weak-feedback communication mechanism, so that the first communication device can determine the first modulation and coding scheme based on source distribution and an actual channel state of the current channel. This helps improve coding performance of the transmit end of the coded data.

In an embodiment, the second communication device sends second feedback information to the first communication device. The second feedback information indicates correct decoding of the second communication device.

It can be learned that the second communication device can feed back the signal-to-noise ratio information of the current channel and a decoding result to the first communication device according to a strong-feedback communication mechanism. This helps improve coding performance of the transmit end of the coded data.

According to a third aspect, an embodiment of this application provides a radio channel data processing method. The method may be applied to a second communication device. The second communication device may be a transmit end of coded data. Correspondingly, a first communication device is a receive end of the coded data. A data transmission scenario for the first communication device and the second communication device is a downlink data transmission scenario. The second communication device determines, based on source distribution information, a modulation and coding scheme used by the second communication device. The modulation and coding scheme indicates a channel coding matrix and a modulation order that are used by the second communication device to perform modulation and coding on an information bit. The second communication device sends control information to the first communication device. The control information includes the source distribution information and the modulation and coding scheme. The second communication device sends a data stream to the first communication device. The data stream is obtained by the second communication device by performing modulation and coding on the information bit based on the modulation and coding scheme.

It can be learned that the second communication device can determine, based on the source distribution information, the modulation and coding scheme used by the second communication device, and perform modulation and coding on the information bit based on the modulation and coding scheme to obtain the corresponding data stream. This helps improve coding performance of the transmit end of the coded data.

In an embodiment, the second communication device obtains a plurality of source distribution quantization intervals. The second communication device determines, for one source distribution quantization interval in the plurality of source distribution quantization intervals, a channel state quantization interval and a modulation and coding scheme corresponding to the source distribution quantization interval. The source distribution quantization interval corresponds to one or more channel state quantization intervals, the source distribution quantization interval corresponds to one or more modulation and coding schemes, and one channel state quantization interval corresponds to one modulation and coding scheme.

It can be learned that the second communication device can quantize source distribution into the plurality of source distribution quantization intervals, and there is a specific correspondence between each source distribution quantization interval, the channel state quantization interval, and the modulation and coding scheme.

In an embodiment, the second communication device determines a corresponding source distribution quantization interval based on a source distribution probability or a source entropy, and determines a corresponding channel state quantization interval based on a preset signal-to-noise ratio working point. The second communication device determines the corresponding channel coding matrix and modulation order based on the corresponding source distribution quantization interval and the corresponding channel state quantization interval.

It can be learned that when determining the source distribution information, the second communication device can determine the corresponding modulation and coding scheme based on the correspondence. This helps improve coding performance of the transmit end of the coded data.

In an embodiment, the second communication device determines the corresponding channel coding matrix and modulation order and a corresponding first code rate based on a source distribution probability or a source entropy and a preset quantity of resources. The first code rate is a code rate of the channel coding matrix.

It can be learned that the second communication device can determine the first modulation and coding scheme based on the source distribution information and the preset quantity of resources. This helps improve coding performance of the transmit end of the coded data.

In an embodiment, the second communication device determines the modulation order based on a preset signal-to-noise ratio working point, and determines a rate-compatible coding matrix set based on the source distribution probability or the source entropy. The rate-compatible coding matrix set includes one or more coding matrices, and one coding matrix corresponds to one code rate. The second communication device determines the first code rate based on the preset quantity of resources, the modulation order, and a source bit rate, and determines, from the rate-compatible coding matrix set based on the first code rate, a coding matrix corresponding to the first code rate as the channel coding matrix.

It can be learned that the second communication device can determine the first modulation and coding scheme based on the source distribution and an estimated channel state. This helps improve coding performance of the transmit end of the coded data.

In an embodiment, the second communication device determines a rate-compatible coding matrix set based on the source distribution probability or the source entropy. The rate-compatible coding matrix set includes one or more coding matrices, and one coding matrix corresponds to one code rate. The second communication device determines a first relationship that is satisfied between the preset quantity of resources, the modulation order, the first code rate, and a source bit rate. The first code rate is the code rate of the channel coding matrix. The second communication device determines a second relationship that is satisfied between the first code rate and a second code rate. The second code rate is a maximum code rate of a coding matrix indicated by the source distribution information. The second communication device determines the modulation order based on the first relationship and the second relationship, determines the first code rate based on the modulation order and the first relationship, and determines, from the rate-compatible coding matrix set, a corresponding coding matrix as the corresponding channel coding matrix based on the first code rate.

It can be learned that the second communication device can determine the first modulation and coding scheme based on the source distribution and an estimated channel state. This helps improve coding performance of the transmit end of the coded data.

In an embodiment, the second communication device receives first feedback information from the first communication device. The first feedback information includes a signal-to-noise ratio of a channel used by the second communication device to send the data stream to the first communication device.

It can be learned that the first communication device can feed back signal-to-noise ratio information of a current channel to the second communication device according to a weak-feedback communication mechanism, so that the second communication device can determine the modulation and coding scheme based on the source distribution and an actual channel state of the current channel. This helps improve coding performance of the transmit end of the coded data.

In an embodiment, the second communication device receives second feedback information from the first communication device. The second feedback information indicates correct decoding of the first communication device.

It can be learned that the first communication device can feed back the signal-to-noise ratio information of the current channel and a decoding result to the second communication device according to a strong-feedback communication mechanism. This helps improve coding performance of the transmit end of the coded data.

According to a fourth aspect, an embodiment of this application provides a radio channel data processing method. The method may be applied to a first communication device. The first communication device is a receive end of coded data. A data transmission scenario for the first communication device and a second communication device is a downlink data transmission scenario. The first communication device receives control information from the second communication device. The control information includes source distribution information and a modulation and coding scheme, and the modulation and coding scheme is determined based on the source distribution information. The first communication device receives a data stream from the second communication device. The data stream is obtained by the second communication device by performing modulation and coding on an information bit based on the modulation and coding scheme. The first communication device performs demodulation and decoding on the data stream based on the control information.

It can be learned that the first communication device can receive the control information and the data stream that are from the second communication device, and perform demodulation and decoding on the data stream based on the source distribution information in the control information. This helps improve decoding performance of the receive end of the coded data.

In an embodiment, the first communication device demodulates the data stream based on a modulation order indicated by the modulation and coding scheme, and obtains the information bit through decoding based on the source distribution information and a channel coding matrix indicated by the modulation and coding scheme.

It can be learned that the second communication device can add source prior information to a decoding procedure, so that a non-uniform feature of a source can be effectively used. This helps improve decoding performance of the receive end of the coded data.

In an embodiment, the second communication device obtains first information bit soft information and parity bit soft information in the data stream through demodulating, and determines second information bit soft information based on the source distribution information. The second communication device obtains the information bit through decoding based on the second information bit soft information and the parity bit soft information.

It can be learned that the second communication device can add source prior information to a decoding procedure, so that a non-uniform feature of a source can be effectively used. This helps improve decoding performance of the receive end of the coded data.

In an embodiment, the first communication device sends first feedback information to the second communication device. The first feedback information includes a signal-to-noise ratio of a channel used by the second communication device to send the data stream to the first communication device.

It can be learned that the first communication device can feed back signal-to-noise ratio information of a current channel to the second communication device according to a weak-feedback communication mechanism, so that the second communication device can determine the modulation and coding scheme based on the source distribution and an actual channel state of the current channel. This helps improve coding performance of a transmit end of the coded data.

In an embodiment, the first communication device sends second feedback information to the second communication device. The second feedback information indicates correct decoding of the first communication device.

It can be learned that the first communication device can feed back the signal-to-noise ratio information of the current channel and a decoding result to the second communication device according to a strong-feedback communication mechanism. This helps improve coding performance of the transmit end of the coded data.

According to a fifth aspect, an embodiment of this application provides a communication apparatus, including a transceiver unit and a processing unit. The transceiver unit is configured to send an uplink resource request message to a second communication device. The uplink resource request message includes source distribution information and a first modulation and coding scheme, and the first modulation and coding scheme is determined based on the source distribution information. The transceiver unit is further configured to receive an uplink resource allocation message from the second communication device. The uplink resource allocation message includes a second modulation and coding scheme, and the second modulation and coding scheme is a modulation and coding scheme allocated by the second communication device to a first communication device. The processing unit is configured to perform modulation and coding on an information bit based on the second modulation and coding scheme.

In an embodiment, the processing unit is further configured to: obtain a plurality of source distribution quantization intervals, and determine, for one source distribution quantization interval in the plurality of source distribution quantization intervals, a channel state quantization interval and a modulation and coding scheme corresponding to the source distribution quantization interval, where the source distribution quantization interval corresponds to one or more channel state quantization intervals, the source distribution quantization interval corresponds to one or more modulation and coding schemes, and one channel state quantization interval corresponds to one modulation and coding scheme.

In an embodiment, the processing unit is further configured to: determine a corresponding source distribution quantization interval based on a source distribution probability or a source entropy, determine a corresponding channel state quantization interval based on a preset signal-to-noise ratio working point, and determine a corresponding channel coding matrix and modulation order based on the corresponding source distribution quantization interval and the corresponding channel state quantization interval.

In an embodiment, the processing unit is further configured to: determine a corresponding channel coding matrix, modulation order, and first code rate based on a source distribution probability or a source entropy and a preset quantity of resources, where the first code rate is a code rate of the corresponding channel coding matrix.

In an embodiment, that the processing unit is configured to determine a corresponding channel coding matrix, modulation order, and first code rate based on a source distribution probability or a source entropy and a preset quantity of resources is specifically configured to:
determine the modulation order based on a preset signal-to-noise ratio working point;
determine a rate-compatible coding matrix set based on the source distribution probability or the source entropy, where the rate-compatible coding matrix set includes one or more coding matrices, and one coding matrix corresponds to one code rate;
determine the first code rate based on the preset quantity of resources, the modulation order, and a source bit rate; and
determine, from the rate-compatible coding matrix set based on the first code rate, a coding matrix corresponding to the first code rate as the corresponding channel coding matrix.

In an embodiment, that the processing unit is configured to determine a corresponding channel coding matrix, modulation order, and first code rate based on a source distribution probability or a source entropy and a preset quantity of resources is specifically configured to:
determine a rate-compatible coding matrix set based on the source distribution probability or the source entropy, where the rate-compatible coding matrix set includes one or more coding matrices, and one coding matrix corresponds to one code rate;
determine a first relationship that is satisfied between the preset quantity of resources, the modulation order, the first code rate, and a source bit rate, where the first code rate is the code rate of the channel coding matrix;
determine a second relationship that is satisfied between the first code rate and a second code rate, where the second code rate is a maximum code rate of a coding matrix indicated by the source distribution information;
determine the modulation order based on the first relationship and the second relationship;
determine the first code rate based on the modulation order and the first relationship;
and
determine, from the rate-compatible coding matrix set, a corresponding coding matrix as the corresponding channel coding matrix based on the first code rate.

In an embodiment, the transceiver unit is configured to receive first feedback information from the second communication device. The first feedback information includes a signal-to-noise ratio of a channel used by the first communication device to send a data stream to the second communication device.

In an embodiment, the transceiver unit is further configured to receive second feedback information from the second communication device. The second feedback information indicates correct decoding of the second communication device.

According to a sixth aspect, an embodiment of this application provides a communication apparatus, including a transceiver unit. The transceiver unit is configured to receive an uplink resource request message from a first communication device. The uplink resource request message includes source distribution information and a first modulation and coding scheme, and the first modulation and coding scheme is determined based on the source distribution information. The transceiver unit is further configured to send an uplink resource allocation message to the first communication device. The uplink resource allocation message includes a second modulation and coding scheme, and the second modulation and coding scheme is a modulation and coding scheme allocated by the second communication device to the first communication device.

In an embodiment, the transceiver unit is further configured to receive a data stream from the first communication device. The data stream is determined by the first communication device by performing modulation and coding on an information bit based on the second modulation and coding scheme. The communication apparatus further includes a processing unit. The processing unit is configured to perform demodulation and decoding on the data stream based on the second modulation and coding scheme and the source distribution information.

In an embodiment, that the processing unit is configured to perform demodulation and decoding on the data stream based on the second modulation and coding scheme and the source distribution information is specifically configured to:
demodulate the data stream based on a modulation order indicated by the modulation and coding scheme; and
obtain the information bit through decoding based on the source distribution information and a channel coding matrix indicated by the modulation and coding scheme.

In an embodiment, the processing unit is configured to demodulate the data stream based on a modulation order indicated by the modulation and coding scheme is specifically configured to: obtain first information bit soft information and parity bit soft information in the data stream through demodulating.

That the processing unit is configured to obtain the information bit through decoding based on the source distribution information and a channel coding matrix indicated by the modulation and coding scheme is specifically configured to:
determine second information bit soft information based on the source distribution information; and
obtain the information bit through decoding based on the second information bit soft information and the parity bit soft information.

In an embodiment, the transceiver unit is further configured to send first feedback information to the first communication device. The first feedback information includes a signal-to-noise ratio of a channel used by the first communication device to send the data stream to the second communication device.

In an embodiment, the transceiver unit is further configured to send second feedback information to the first communication device. The second feedback information indicates correct decoding of the second communication device.

According to a seventh aspect, an embodiment of this application provides a communication apparatus, including a processing unit and a transceiver unit. The processing unit is configured to determine, based on source distribution information, a modulation and coding scheme used by a second communication device. The transceiver unit is further configured to send control information to a first communication device. The control information includes the source distribution information and the modulation and coding scheme. The transceiver unit is further configured to send a data stream to the first communication device. The data stream is obtained by the second communication device by performing modulation and coding on an information bit based on the modulation and coding scheme.

In an embodiment, the processing unit is further configured to:
obtain a plurality of source distribution quantization intervals; and
determine, for one source distribution quantization interval in the plurality of source distribution quantization intervals, a channel state quantization interval and a modulation and coding scheme corresponding to the source distribution quantization interval, where the source distribution quantization interval corresponds to one or more channel state quantization intervals, the source distribution quantization interval corresponds to one or more modulation and coding schemes, and one channel state quantization interval corresponds to one modulation and coding scheme.

In an embodiment, that the processing unit is configured to determine, based on source distribution information, a modulation and coding scheme used by a second communication device is specifically configured to:
determine a corresponding source distribution quantization interval based on a source distribution probability or a source entropy;
determine a corresponding channel state quantization interval based on a preset signal-to-noise ratio working point; and
determine a corresponding channel coding matrix and modulation order based on the corresponding source distribution quantization interval and the corresponding channel state quantization interval.

In an embodiment, that the processing unit is configured to determine, based on source distribution information, a modulation and coding scheme used by a second communication device is specifically configured to:
determine a corresponding channel coding matrix, modulation order, and first code rate based on a source distribution probability or a source entropy and a preset quantity of resources, where the first code rate is a code rate of the channel coding matrix.

In an embodiment, that the processing unit is configured to determine a corresponding channel coding matrix, modulation order, and first code rate based on a source distribution probability or a source entropy and a preset quantity of resources is specifically configured to:
determine the modulation order based on a preset signal-to-noise ratio working point;
determine a rate-compatible coding matrix set based on the source distribution probability or the source entropy, where the rate-compatible coding matrix set includes one or more coding matrices, and one coding matrix corresponds to one code rate;
determine the first code rate based on the preset quantity of resources, the modulation order, and a source bit rate; and
determine, from the rate-compatible coding matrix set based on the first code rate, a coding matrix corresponding to the first code rate as the channel coding matrix.

In an embodiment, that the processing unit is configured to determine a corresponding channel coding matrix, modulation order, and first code rate based on a source distribution probability or a source entropy and a preset quantity of resources is specifically configured to:
determine a rate-compatible coding matrix set based on the source distribution probability or the source entropy, where the rate-compatible coding matrix set includes one or more coding matrices, and one coding matrix corresponds to one code rate;
determine a first relationship that is satisfied between the preset quantity of resources, the modulation order, the first code rate, and a source bit rate, where the first code rate is the code rate of the channel coding matrix;
determine a second relationship that is satisfied between the first code rate and a second code rate, where the second code rate is a maximum code rate of a coding matrix indicated by the source distribution information;
determine the modulation order based on the first relationship and the second relationship;
determine the first code rate based on the modulation order and the first relationship; and
determine, from the rate-compatible coding matrix set, a corresponding coding matrix as the corresponding channel coding matrix based on the first code rate.

In an embodiment, the transceiver unit is further configured to receive first feedback information from the first communication device. The first feedback information includes a signal-to-noise ratio of a channel used by the second communication device to send the data stream to the first communication device.

In an embodiment, the transceiver unit is further configured to receive second feedback information from the first communication device. The second feedback information indicates correct decoding of the first communication device.

According to an eighth aspect, an embodiment of this application provides a communication apparatus, including a transceiver unit and a processing unit. The transceiver unit is configured to receive control information from a second communication device. The control information includes source distribution information and a modulation and coding scheme, and the modulation and coding scheme is determined based on the source distribution information. The transceiver unit is further configured to receive a data stream from the second communication device. The data stream is obtained by the second communication device by performing modulation and coding on an information bit based on the modulation and coding scheme. The processing unit is configured to perform demodulation and decoding on the data stream based on the control information.

In an embodiment, that the processing unit is configured to perform demodulation and decoding on the data stream based on the control information is specifically configured to: demodulate the data stream based on a modulation order indicated by the modulation and coding scheme; and obtain the corresponding information bit through decoding based on the source distribution information and a channel coding matrix indicated by the modulation and coding scheme.

In an embodiment, that the processing unit is configured to demodulate the data stream based on a modulation order indicated by the modulation and coding scheme is specifically configured to:
obtain first information bit soft information and parity bit soft information in the data stream through demodulating.

That the processing unit is configured to obtain, through decoding based on the source distribution information and a channel coding matrix indicated by the modulation and coding scheme, the information bit included in the demodulated data stream is specifically configured to:
determine second information bit soft information based on the source distribution information; and
obtain the information bit through decoding based on the second information bit soft information and the parity bit soft information.

In an embodiment, the transceiver unit is further configured to send first feedback information to the second communication device. The first feedback information includes a signal-to-noise ratio of a channel used by the second communication device to send the data stream to a first communication device.

In an embodiment, the transceiver unit is further configured to send second feedback information to the second communication device. The second feedback information indicates correct decoding of the first communication device.

According to a ninth aspect, an embodiment of this application provides a communication device. The device has a function of implementing the radio channel data processing method provided in the first aspect. The function may be implemented by hardware, or may be implemented by hardware executing corresponding software. The hardware or the software includes one or more modules corresponding to the function.

According to a tenth aspect, an embodiment of this application provides a communication device. The device has a function of implementing the radio channel data processing method provided in the second aspect. The function may be implemented by hardware, or may be implemented by hardware executing corresponding software. The hardware or the software includes one or more modules corresponding to the function.

According to an eleventh aspect, an embodiment of this application provides a communication device. The device has a function of implementing the radio channel data processing method provided in the third aspect. The function may be implemented by hardware, or may be implemented by hardware executing corresponding software. The hardware or the software includes one or more modules corresponding to the function.

According to a twelfth aspect, an embodiment of this application provides a communication device. The device has a function of implementing the radio channel data processing method provided in the fourth aspect. The function may be implemented by hardware, or may be implemented by hardware executing corresponding software. The hardware or the software includes one or more modules corresponding to the function.

According to a thirteenth aspect, an embodiment of this application provides a communication system. The communication system includes the communication devices provided in the ninth aspect and the tenth aspect, or the communication devices provided in the eleventh aspect and the twelfth aspect.

According to a fourteenth aspect, an embodiment of this application provides a computer-readable storage medium. The readable storage medium includes a program or instructions. When the program or the instructions are run on a computer, the computer is enabled to perform the method according to any one of the first aspect or the embodiments of the first aspect.

According to a fifteenth aspect, an embodiment of this application provides a computer-readable storage medium. The readable storage medium includes a program or instructions. When the program or the instructions are run on a computer, the computer is enabled to perform the method according to any one of the second aspect or the embodiments of the second aspect.

According to a sixteenth aspect, an embodiment of this application provides a computer-readable storage medium. The readable storage medium includes a program or instructions. When the program or the instructions are run on a computer, the computer is enabled to perform the method according to any one of the third aspect or the embodiments of the third aspect.

According to a seventeenth aspect, an embodiment of this application provides a computer-readable storage medium. The readable storage medium includes a program or instructions. When the program or the instructions are run on a computer, the computer is enabled to perform the method according to any one of the fourth aspect or the embodiments of the fourth aspect.

According to an eighteenth aspect, an embodiment of this application provides a chip or a chip system. The chip or the chip system includes at least one processor and an interface, the interface is interconnected to the at least one processor through a line, and the at least one processor is configured to run a computer program or instructions, to perform the method described in any one of the first aspect or the embodiments of the first aspect.

According to a nineteenth aspect, an embodiment of this application provides a chip or a chip system. The chip or the chip system includes at least one processor and an interface, the interface is interconnected to the at least one processor through a line, and the at least one processor is configured to run a computer program or instructions, to perform the method described in any one of the second aspect or the embodiments of the second aspect.

According to a twentieth aspect, an embodiment of this application provides a chip or a chip system. The chip or the chip system includes at least one processor and an interface, the interface is interconnected to the at least one processor through a line, and the at least one processor is configured to run a computer program or instructions, to perform the method described in any one of the third aspect or the embodiments of the third aspect.

According to a twenty-first aspect, an embodiment of this application provides a chip or a chip system. The chip or the chip system includes at least one processor and an interface, the interface is interconnected to the at least one processor through a line, and the at least one processor is configured to run a computer program or instructions, to perform the method described in any one of the fourth aspect or the embodiments of the fourth aspect.

The interface in the chip may be an input/output interface, a pin, a circuit, or the like.

The chip system in the foregoing aspects may be a system on chip (SOC), a baseband chip, or the like. The baseband chip may include a processor, a channel encoder, a digital signal processor, a modem, an interface module, and the like.

In a possible implementation, the chip or the chip system described in this application further includes at least one memory, and the at least one memory stores instructions. The memory may be a storage unit inside the chip, for example, a register or a cache, or may be a storage unit (for example, a read-only memory or a random access memory) of the chip.

According to a twenty-second aspect, an embodiment of this application provides a computer program or a computer program product, including code or instructions. When the code or the instructions are run on a computer, the computer is enabled to perform the method according to any one of the first aspect or the embodiments of the first aspect.

According to a twenty-third aspect, an embodiment of this application provides a computer program or a computer program product, including code or instructions. When the code or the instructions are run on a computer, the computer is enabled to perform the method according to any one of the second aspect or the embodiments of the second aspect.

According to a twenty-fourth aspect, an embodiment of this application provides a computer program or a computer program product, including code or instructions. When the code or the instructions are run on a computer, the computer is enabled to perform the method according to any one of the third aspect or the embodiments of the third aspect.

According to a twenty-fifth aspect, an embodiment of this application provides a computer program or a computer program product, including code or instructions. When the code or the instructions are run on a computer, the computer is enabled to perform the method according to any one of the fourth aspect or the embodiments of the fourth aspect.

### BRIEF DESCRIPTION OF DRAWINGS

FIG. 1 is a schematic diagram of a conventional digital video transmission scheme based on independent source and channel coding;

FIG. 2a is a schematic diagram of distribution statuses of compressed data and uncompressed data in a video;

FIG. 2b is a schematic diagram of a distribution status of application data of a terminal;

FIG. 3 is a schematic flowchart of a source-channel joint coding method;

FIG. 4 is a schematic diagram of a communication system according to an embodiment of this application;

FIG. 5 is a schematic diagram of a relationship between a source distribution probability and a source entropy;

FIG. 6 is a schematic flowchart of a radio channel data processing method according to an embodiment of this application;

FIG. 7a is a schematic flowchart of a procedure in which a receive end of coded data performs demodulation and decoding on a data stream according to an embodiment of this application;

FIG. 7b is a schematic flowchart of another procedure in which a receive end of coded data performs demodulation and decoding on a data stream according to an embodiment of this application;

FIG. 8 is a schematic flowchart of another radio channel data processing method according to an embodiment of this application;

FIG. 9a is a schematic flowchart of a radio channel data processing method in a non-feedback communication mechanism according to an embodiment of this application;

FIG. 9b is a schematic flowchart of a radio channel data processing method in a weak-feedback communication mechanism according to an embodiment of this application;

FIG. 9c is a schematic flowchart of a radio channel data processing method in a strong-feedback communication mechanism according to an embodiment of this application;

FIG. 10 is a schematic diagram of a communication apparatus according to an embodiment of this application;

FIG. 11 is a schematic diagram of a first communication device according to an embodiment of this application;

FIG. 12 is a schematic diagram of another communication apparatus according to an embodiment of this application;

FIG. 13 is a schematic diagram of a second communication device according to an embodiment of this application;

FIG. 14 is a schematic diagram of another communication apparatus according to an embodiment of this application;

FIG. 15 is a schematic diagram of another second communication device according to an embodiment of this application;

FIG. 16 is a schematic diagram of another communication apparatus according to an embodiment of this application; and

FIG. 17 is a schematic diagram of another first communication device according to an embodiment of this application.

### DESCRIPTION OF EMBODIMENTS

The following describes the technical solutions in embodiments of this application with reference to the accompanying drawings in embodiments of this application.

With development of information technologies, people put forward higher requirements for enjoying multimedia services such as voice, data, image, and video anytime and anywhere. Therefore, the multimedia communication field has become a focus of people's attention. With development of wireless communication, a coding and transmission technology of a multimedia service in a radio channel has become a research hotspot in the multimedia communication field.

Due to a limited bandwidth of a radio channel, multimedia service data (such as video data) needs to be efficiently compressed. However, currently technologies such as predictive coding and variable-length coding used for video coding make a bit stream very sensitive to a bit error rate of a channel while being used to efficiently compress the multimedia service data. Various types of noise interference in the radio channel result in a high bit error rate of the channel. Therefore, how to improve coding and decoding performance of a data receive end and a data transmit end in a wireless network to ensure reliability of data transmission becomes a problem to be resolved.

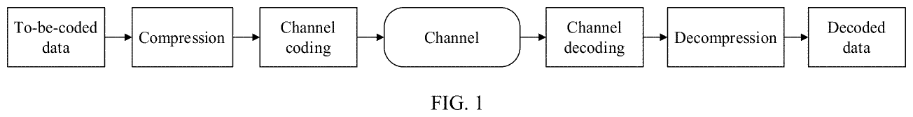

Coding is one of key problems. Coding is mainly classified into source coding and channel coding. A main objective of the source coding is to improve coding efficiency. A main objective of the channel coding is to improve reliability of information transmission. A conventional digital video transmission scheme based on independent source and channel coding is shown in FIG. 1. This system requires not only a physical layer adaptation algorithm, but also a video code rate control algorithm. When a video code rate does not match a channel capacity, cliff effect similar to that of a physical layer occurs. To be specific, if channel noise is greater than a predicted value, distortion of a reconstructed video is very large; or if channel noise is less than a predicted value, distortion is not reduced. That is, the traditional digital video transmission scheme based on independent source and channel coding may cause distortion in video transmission, and consequently reduces the reliability of information transmission.

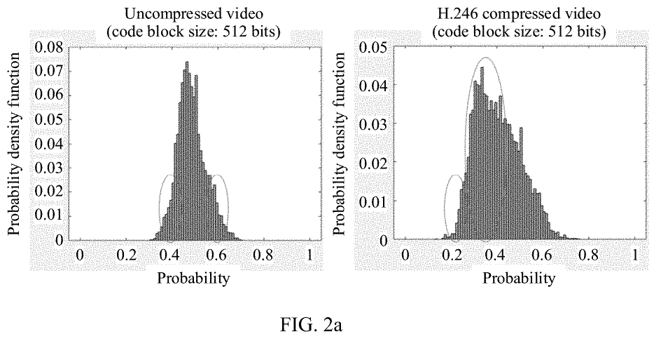

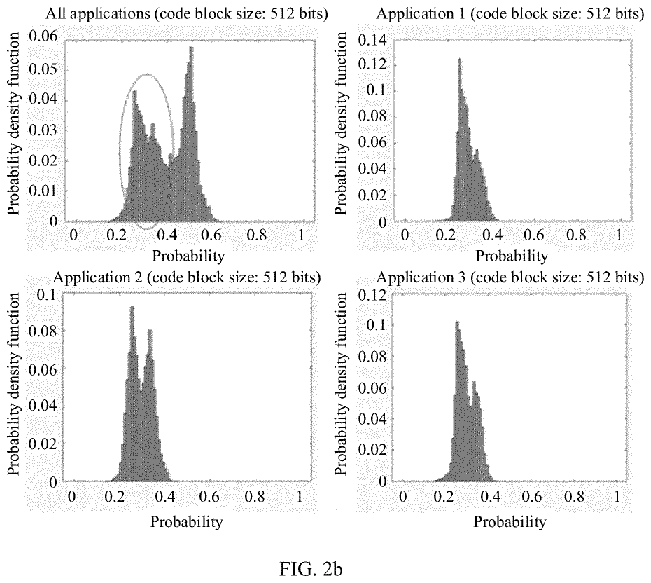

In addition, currently data transmitted in a wireless network includes not only evenly distributed data, but also non-uniformly distributed data. Refer to FIG. 2a and FIG. 2b. FIG. 2a is a schematic diagram of distribution of compressed data and uncompressed data in a video, and FIG. 2b is a schematic diagram of distribution of application data of a terminal. The compressed data in FIG. 2a is data on which video compression is performed by using H.246. The application data in FIG. 2b comes from a plurality of popular applications, for example, an application 1, an application 2, and an application 3. It can be seen from FIG. 2a and FIG. 2b that, currently most data transmitted in the wireless network is the non-uniformly distributed data. If coding is performed based on the conventional digital video transmission scheme, data transmission reliability may be reduced.

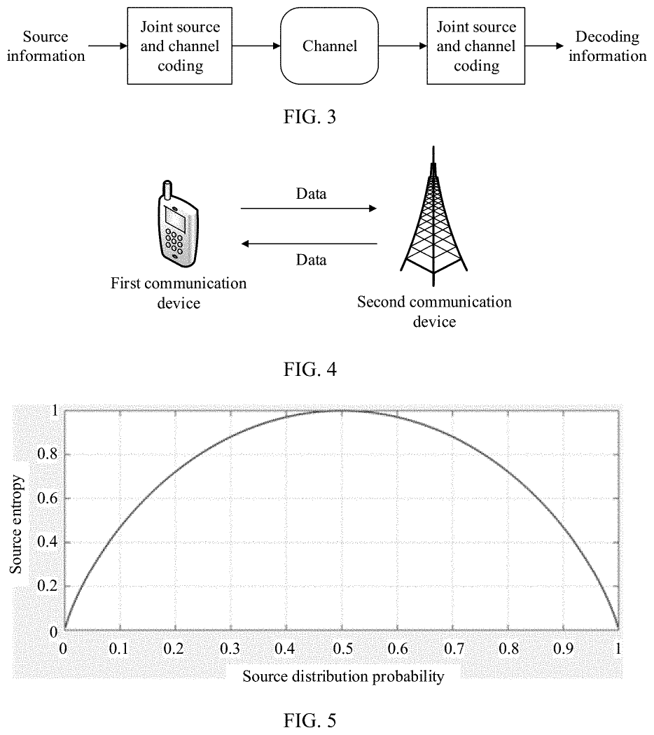

To resolve problems that the foregoing non-uniformly distributed data cannot be adaptively transmitted on a channel and a transmission delay is high, a joint source-channel coding (JSCC) method, as shown in FIG. 3, is provided in the academic community. In this method, source coding and channel coding are combined to compress a source, resist channel fading, and prevent a signal loss. For example, an independent coding matrix is used for implementation, and all coding matrices corresponds to different code rates, to support data transmission in different scenarios. However, no specific implementation of how to determine channel coding matrices and/or modulation orders that support different scenarios is provided in existing joint source-channel coding.

In view of this, an embodiment of this application provides a radio channel data processing method. The method may be performed by a first communication device. The first communication device may be a terminal device. According to the method, modulation and coding schemes that support different scenarios can be determined based on source distribution information. This helps improve coding and decoding performance of a data receive end and a data transmit end in a wireless network, and helps improve data transmission reliability.

The radio channel data processing method may be applied to a communication system shown in FIG. 4. The communication system includes the first communication device and a second communication device.

The first communication device may be a terminal device having a wireless transceiver function, or the first communication device may be a chip. The terminal device may be user equipment (UE), a mobile phone, a tablet computer (Pad), a computer with a wireless transceiver function, a virtual reality (VR) terminal device, an augmented reality (AR) terminal device, a vehicle-mounted terminal device, a wireless terminal in remote medical, a wireless terminal in a smart grid, a wearable terminal device, a device having a communication function in the Internet of Things (IoT), or the like.

The second communication device may be any network device having a wireless transceiver function, and provides a wireless communication service for the first communication device in a coverage area. The network device may include but is not limited to: an evolved NodeB (NodeB or eNB or e-NodeB, evolved NodeB) in a long term evolution (LTE) system, a base station (gNodeB or gNB) or a transmission reception point (transmission receiving point/transmission reception point, TRP) in a new-generation radio access technology (NR), a base station that subsequently evolves in 3GPP, an access node in a Wi-Fi system, a wireless relay node, a wireless backhaul node, a device that provides a base station function in vehicle-to-everything (V2X), device-to-device (D2D) communication, and machine-to-machine communication, a satellite, or the like.

For ease of understanding, the following explains related terms in embodiments of this application.

A source is a device that generates and sends information during communication. In embodiments of this application, the source may be a transmit end of coded data. In embodiments of this application, both the first communication device and the second communication device may be sources. To be specific, when the first communication device is a source, the second communication device is a receive end of the coded data. When the second communication device is a source, the first communication device is a receive end of the coded data. Optionally, the source can quantize source distribution into a plurality of discrete source distribution quantization intervals based on a source distribution probability or a source entropy.

Source distribution probability: A most basic source is a single message (symbol) source, can be represented by a random variable X and its probability distribution p₁, is usually denoted as (X, p₁). A value range of the source distribution probability p₁ is 0 to 1. If a quantization bit width is B, the source distribution probability may be evenly divided into 2B parts: 0, 1/(2B− 1), 2/(2B− 1), . . . , 1 or 1/2B, 2/2B, . . . , 1.

A source entropy indicates mathematical expectation of respective information volume of discrete messages of a source. In other words, the source entropy is a weighted statistical average value of a source distribution probability, that is, the source entropy is represented as H (p₁)=p₁×log₂ (1/p₁)+(1/p₁)× log (1/(1−p₁)) A value range of H (p₁) is 0 to 1, and each value except 0.5 corresponds to two complementary probability values, that is, p₁+q₁=1, H(p₁)=H(q₁). If a quantization bit width is B, 1 bit indicates p₁≤0.5 or p₁>0.5 and remaining B− 1 bits indicate a value of the source entropy. To be specific, when p₁≤0.5 H(p₁)=1/2B−1,2/2B−1, . . . , 1 or when p₁>0.5 H(p₁)=0,1/2^{B-1}, . . . ,(2^{B}−1)/2^{B-1}. It can be learned that an original source distribution probability may be restored based on an indication of the source entropy.

FIG. 5 is a schematic diagram of a relationship between a source distribution probability and a source entropy. It is assumed that the source is quantized by using 4 bits. For the source distribution probability p₁, p₁=0,1/15,2/15, . . . , 1 or p₁=1/16, 2/16, . . . , 1. For the source entropy H(p₁), 1 bit indicates p₁≤0.5 or p₁>0.5, and 3 bits indicate the source entropy. For example, when p₁≤0.5, H(p₁)=1/8, 2/8, . . . , 1 or when p₁>0.5 H(p₁)=0, 1/8, . . . , 7/8, as shown in FIG. 5.

A channel, as a basis in the communication field, is a signal channel based on a transmission medium. Channels are classified into narrow-sense channels and broad-sense channels. Influence of the channel on a signal may include distortion or distortion, additional noise, and the like. The channels in embodiments of this application are narrow-sense channels, and the narrow-sense channels are classified into modulation channels and coding channels. The modulation channel is a part from an output of a modulator to an input end of a demodulator. The coding channel is a part from an output end of a coder to an input end of a decoder. Influence of the modulation channel on a signal is to make a change of a modulated signal in an analog domain, and influence of the coding channel on a signal is to make a change in a digital domain. Generally, the modulation channel may be considered as an analog channel, and a coding channel may be considered as a digital channel. Optionally, a channel state may be quantized into a plurality of discrete channel state quantization intervals based on a signal-to-noise ratio (SNR) of the channel.

A signal-to-noise ratio indicates a ratio of a signal level to a noise level. The unit is decibel (dB). In other words, the SNR may be represented as a ratio of a transmit power to a noise power. The SNR is an important parameter for measuring influence of noise on a signal. The SNR may be improved by improving transmission means and enhancing a device capability.

A modulation and coding scheme (MSC) includes information such as a channel coding matrix and a modulation scheme that are used when a transmit end of coded data performs modulation and coding on an information bit. For example, the MCS in embodiments of this application includes information such as a channel coding matrix, a code rate of the channel coding matrix, a modulation scheme, and a modulation order.

The following describes in detail embodiments of this application.

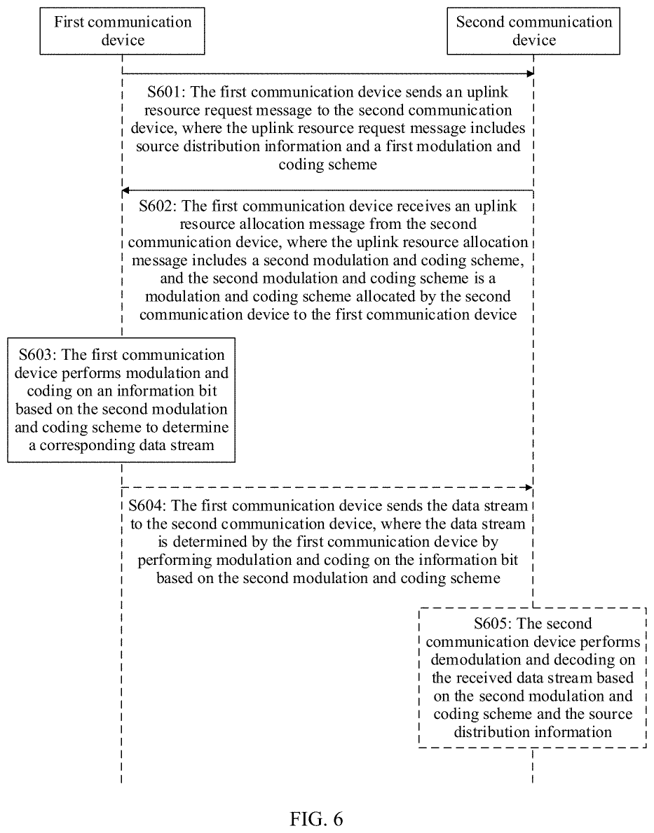

FIG. 6 is a schematic flowchart of a radio channel data processing method according to an embodiment of this application. The radio channel data processing method may be implemented through interaction between a first communication device and a second communication device. In this embodiment, the first communication device is a transmit end of coded data, and the second communication device is a receive end of the coded data. The method may include the following steps.

S601: The first communication device sends an uplink resource request message to the second communication device. The uplink resource request message includes source distribution information and a first modulation and coding scheme, and the first modulation and coding scheme is determined based on the source distribution information.

S602: The first communication device receives an uplink resource allocation message from the second communication device. The uplink resource allocation message includes a second modulation and coding scheme, and the second modulation and coding scheme is a modulation and coding scheme allocated by the second communication device to the first communication device.

S603: The first communication device performs modulation and coding on an information bit based on the second modulation and coding scheme to determine a corresponding data stream.

As the transmit end of the coded data, the first communication device may obtain the source distribution information. The source distribution information may include but is not limited to a source distribution probability, a source entropy, a preset quantity of resources, or the like. The source distribution probability may be understood as a probability of a bit “1” in each code block collected after the information bits are respectively divided into a plurality of code blocks. For example, the first communication device may divide N information bits into M to-be-coded blocks, and collect statistics on the probability of a bit “1” in each of the M to-be-coded blocks. If information bits included in one to-be-coded block are 00010000, the source distribution probability of the to-be-coded block is 1/8. The source entropy is a statistical average value weighted by the source distribution probability, that is, the source entropy is determined according to the source distribution probability. Optionally, statistics on the source distribution probability may be collected at a physical layer or at a media access control (MAC) layer. This is not limited in this embodiment.

The preset quantity of resources is a quantity of transmission resources such as time-domain transmission resources and frequency-domain transmission resources that are allocated by a system. For example, a quantity of frequency-domain transmission resources allocated by the system may be a quantity of resource blocks (RB) allocated by the system to the first communication device for data transmission, that is, a quantity of RBs. The preset quantity of resources may be indicated to the first communication device based on downlink control information (DCI).

The first modulation and coding scheme is determined by the first communication device based on the source distribution information. For example, the first communication device may determine the first modulation and coding scheme based on the source distribution probability. Further, the first modulation and coding scheme may be determined by the first communication device based on the source distribution information and channel state information. That is, both a channel state and source distribution are considered in the first modulation and coding scheme described in this embodiment. This helps enhance coding performance. The channel state information indicates a state of a channel for transmitting the coded data, and may include but is not limited to information such as a channel SNR and a channel attenuation coefficient.

In an example, there is a correspondence between the source distribution, the channel state, and the modulation and coding scheme. The source distribution may be represented by using a source distribution quantization value (for example, the source distribution probability), and the channel state may be represented by using a channel state quantization value (for example, the SNR). For ease of description, it is assumed that the first communication device can respectively store the source distribution quantization value and the channel state quantization value in a form of a table in this embodiment.

Table 1 is a quantization table of source distribution and a channel state provided in this embodiment of this application. p_{1,m} represents an m^{th} source distribution quantization value, SNR_{m,N}_{ₘ} represents a channel state quantization value under the m^{th} source distribution quantization value, and m=1, 2, . . . , M Different source distribution quantization values do not necessarily correspond to a same quantity of channel states, that is, N₁, N₂, . . . , N_{M} are not completely the same. It may be understood that the quantization table of the source distribution and the channel state shown in Table 1 may be obtained by the first communication device through simulation statistics.

TABLE 1
A quantization table of source distribution and a channel state

| Source | | |
|---|---|---|
| distribution | | |
| quantization | | |
| value | Channel state quantization value | |
| p_{1, 1} | SNR_{1, 1}, SNR_{1, 2}, . . . , SNR_{1, N}_{₁} | SNR_{m, Nm+1} = +∞, |
| p_{1, 2} | SNR_{2, 1}, SNR_{2, 2}, . . . , SNR_{2, N}_{₂} | m = 1, 2, . . . , M |
| . . . | . . . | |
| p_{1, M} | SNR_{M, 1}, SNR_{M, 2}, . . . , SNR_{M, N}_{_{M}} | |

It can be seen that, as described in Table 1, one source distribution probability p_{1,m} may correspond to one or more channel state quantization values. It may be understood that one source distribution probability in Table 1 may indicate one source distribution quantization interval, for example, p_{1,1} indicates a source distribution quantization interval 1. A group of channel state quantization values may indicate one or more channel state quantization intervals, for example, [SNR_{1,1},SNR_{1,2}) indicates a channel state quantization interval 1, [SNR_{1,2},SNR_{1,3}) indicates a channel state quantization interval 2, and so on. That is, one source distribution quantization interval corresponds to one or more channel state quantization intervals.

Optionally, one source distribution quantization interval may correspond to one or more modulation and coding schemes. For example, one source distribution quantization interval shown in Table 1 may correspond to

$${\sum }_{m = 1}^{M} {N}_{m}$$

groups of MCSs, which are respectively denoted as MCSᵢ(Cᵢ, Modᵢ)*Cᵢ represents a channel coding matrix, Modᵢ represents a modulation order, and

$$i = 1 , 2 , … , {\sum }_{m = 1}^{M} {N}_{m}$$

The channel coding matrix Cᵢ in the MCS described in this embodiment may also be represented by a check matrix H, and the check matrix H, and the channel coding matrix Cᵢ satisfy a modulo-2 orthogonality relation, that is, mod(Hᵢ*Cᵢ,2)=0.

Optionally, the correspondence between the source distribution, the channel state, and the modulation and coding scheme may be established as a two-dimensional mapping relationship, and the two-dimensional mapping relationship may be represented as MCS=f(p₁,SNR) For example, Table 2 is a table of a mapping relationship between an MCS, a source distribution quantization interval, and a channel state quantization interval provided in this embodiment of this application. One source distribution quantization interval in Table 2 is a quantization interval within which one source distribution probability falls.

TABLE 2
Table of a mapping relationship between an MCS, a source distribution
quantization interval, and a channel state quantization interval

Source distribution quantization interval 1

| | | | | |
|---|---|---|---|---|
| Channel state | [SNR_{1,1}, SNR_{1,2}) | [SNR_{1,2}, SNR_{1,3}) | . . . | [SNR_{1,N}_{₁}, +∞) |
| quantization interval | | | | |
| MCS | (C₁, Mod₁) | (C₂, Mod₂) | . . . | (C_{N}_{₁}, Mod_{N}_{₁}) |

Source distribution quantization interval 2

| | | | | |
|---|---|---|---|---|
| Channel state | [SNR_{2,1}, SNR_{2,2}) | [SNR_{2,2}, SNR_{2,3}) | . . . | [SNR_{2,N}_{₁}, +∞) |
| quantization interval | | | | |
| MCS | (C_{N}_{₁}₊₁, Mod_{N}_{₁}₊₁) | (C_{N}_{₁}₊₂, Mod_{N}_{₁}₊₂) | . . . | (C_{N}_{₁}_{+N}_{₂}, Mod_{N}_{₁}_{+N}_{₂}) |

. . .
Source distribution quantization interval M

| | | | | |
|---|---|---|---|---|
| Channel state | [SNR_{M,1}, SNR_{M,2}) | [SNR_{M,2}, SNR_{M,3}) | . . . | [SNR_{M,N}_{₁}, +∞) |
| quantization interval | | | | |
| MCS | $( {C}_{{\sum }_{m = 1}^{M - 1} {N}_{m} + 1} , {Mod}_{{\sum }_{m = 1}^{M - 1} {N}_{m} + 1} )$ | $( {C}_{{\sum }_{m = 1}^{M - 1} {N}_{m} + 2} , {Mod}_{{\sum }_{m = 1}^{M - 1} {N}_{m} + 2} )$ | . . . | $( {C}_{{\sum }_{m = 1}^{M} {N}_{m}} , {Mod}_{{\sum }_{m = 1}^{M} {N}_{m}} )$ |

The first communication device may determine the corresponding first modulation and coding scheme based on the source distribution information and the correspondence between the source distribution, the channel state, and the modulation and coding scheme. Specifically, the first communication device determining the first modulation and coding scheme based on the source distribution information may include the following steps:
s11: The first communication device determines a corresponding source distribution quantization interval based on the source distribution probability or the source entropy.
s12: The first communication device determines a corresponding channel state quantization interval based on a preset signal-to-noise ratio working point.
s13: The first communication device determines a corresponding channel coding matrix and modulation order based on the corresponding source distribution quantization interval and the corresponding channel state quantization interval.

For example, the first communication device determines, based on the source distribution probability, that the corresponding source distribution quantization interval is the source distribution quantization interval 2 shown in Table 2, and then determines, based on the preset signal-to-noise ratio working point, that the corresponding channel state quantization interval is [SNR_{2,2},SNR_{2,3}). In this case, the first communication device may determine, based on the mapping relationship shown in Table 2, that the channel coding matrix is C_{N}_{₁}₊₂ and the modulation order is Mod_{N}_{₁}₊₂.

The first communication device may determine, in the following two manners, the source distribution quantization interval within which the source distribution probability falls.

Manner 1: The source distribution quantization interval within which the source distribution probability falls is determined in a minimum distance manner. For example, identifiers of the source distribution quantization intervals shown in Table 2 are 1, 2, . . . , m, . . . , and M. m is set to satisfy the following minimum distance m=arg min|p₁, p_{1,i}|. If p₁ in the middle of two source distribution probabilities, a sequence number corresponding to a larger probability value is selected for m. When m=arg min|p₁, p_{1,i}|, and SNR∈[SNR_{m,n},SNR_{m,n+1}) the first communication device determines that the first modulation and coding scheme is (Cᵢ,Modᵢ) and

$$i = {\sum }_{i = 1}^{m - 1} {N}_{i} + n .$$

Manner 2: The source distribution quantization interval within which the source distribution probability falls is determined in an interval specifying manner. For example, set p_{1,0}=0 which represents a lower limit of the source distribution quantization interval when m=1. When p₁∈(p_{1,m-1},p_{1,m}] and SNR∈[SNR_{m,n},SNR_{m,n+1}, the first communication device determines that the first modulation and coding scheme is (Cᵢ,Modᵢ) and

$$i = {\sum }_{i = 1}^{m - 1} {N}_{i} + n .$$

Optionally, if MCSs use a same modulation order, that is,

$${Mod}_{1} = {Mod}_{2} = … = {Mod}_{{\sum }_{m = 1}^{M} {N}_{m}} ,$$

the system adjusts only the channel coding matrix.

The following describes in detail the mapping relationship shown in Table 2 by using a specific example. In this example, the source distribution is represented by two bits. In this case, Table 2 may be rewritten as Table 3. Table 3 is a table of a mapping relationship between an MCS, a source distribution quantization interval, and a channel state quantization interval, that is obtained when the source distribution is represented by the two bits, provided in this embodiment of this application. It may be understood that the mapping table is merely an example, and another quantity of bits (for example, four bits) may be used to represent the source distribution. This is not limited in this embodiment.

TABLE 3
Table of a mapping relationship between an MCS, a source distribution
quantization interval, and a channel state quantization interval, that
is obtained when source distribution is represented by two bits
Source distribution quantization interval 1, p₁ ∈ [0, 0.25]

| | | | |
|---|---|---|---|
| Channel state | SNR ∈ [3 dB, 9 dB) | SNR ∈ [9 dB, 15 dB) | SNR ∈ [15 dB, +∞) |
| quantization | | | |
| interval | | | |
| MCS | (H₁, QPSK) | (H₂, 16QAM) | (H₃, 64QAM) |

Source distribution quantization interval 2, p₁ ∈ (0.25, 0.5]

| | | | |
|---|---|---|---|
| Channel state | SNR ∈ [3 dB, 9 dB) | SNR ∈ [9 dB, 15 dB) | SNR ∈ [15 dB, +∞) |
| quantization | | | |
| interval | | | |
| MCS | (H₄, QPSK) | (H₅, 16QAM) | (H₆, 64QAM) |

Source distribution quantization interval 3, p₁ ∈ (0.5, 0.75]

| | | | |
|---|---|---|---|
| Channel state | SNR ∈ [3 dB, 9 dB) | SNR ∈ [9 dB, 15 dB) | SNR ∈ [15 dB, +∞) |
| quantization | | | |
| interval | | | |
| MCS | (H₇, QPSK) | (H₈, 16QAM) | (H₉, 64QAM) |

Source distribution quantization interval 4, p₁ ∈ (0.75, 1]

| | | | |
|---|---|---|---|
| Channel state | SNR ∈ [3 dB, 9 dB) | SNR ∈ [9 dB, 15 dB) | SNR ∈ [15 dB, +∞) |
| quantization | | | |
| interval | | | |
| MCS | (H₁₀, QPSK) | (H₁₁, 16QAM) | (H₁₂, 64QAM) |

An example of the check matrix Hᵢ, i=1, 2, . . . , 12 shown in Table 3 is as follows:
H₁=[1 0 0 1 1 0 0 1; 0 1 1 0 1 1 0 0; 0 1 0 1 0 1 1; 1 0 1 0 0 1 0], 1/2 code rate;
H₂=[1 0 0 1 1 0 0 1; 0 1 1 0 0 1 1 0], 3/4 code rate;
H₃=[1 0 0 1 1 0 0 1 0 1 1 0 0 1 1 0; 0 1 1 0 0 1 1 0 1 0 0 1 1 0 0 1], 7/8 code rate;
H₄=[1 0 1 0 1 0 0 1 0 1 1 0 0 1 1 0; 0 1 1 0 0 1 1 0 1 0 0 1 1 0 0 1; 0 1 0 1 0 1 0 1 1 0 1 0 1 0 1 0; 1 0 0 1 1 0 1 0 0 1 0 1 0 1 0 1], 1/4 code rate;
H₅=[1 0 1 0 0 1 0 1; 0 1 1 0 1 0 1 0; 0 1 0 1 0 1 0 1; 1 0 0 1 1 0 1 0], 1/2 code rate;
H₆=[0 1 0 1 1 0 0 1; 1 0 1 0 0 1 1 0], 3/4 code rate;
H₇=[1 0 1 0 1 0 0 1 0 1 1 0 0 1 1 0; 0 1 1 0 0 1 1 0 1 0 0 1 1 0 0 1; 0 1 0 1 0 1 0 1 1 0 1 0 1 0 1 0; 1 0 0 1 1 0 1 0 0 1 0 1 0 1 0 1], 1/4 code rate;
H₈=[1 0 1 0 0 1 0 1; 0 1 1 0 1 0 1 0; 0 1 0 1 0 1 0 1; 1 0 0 1 1 0 1 0], 1/2 code rate;
H=[0 1 0 1 1 0 0 1; 1 0 1 0 0 1 1 0], 3/4 code rate;
H₁₀=[1 0 0 1 1 0 0 1; 0 1 1 0 1 1 0 0; 0 1 0 1 0 0 1 1; 1 0 1 0 0 1 1 0], 1/2 code rate;
H₁₁=[1 0 0 1 1 0 0 1; 0 1 1 0 0 1 1 0], 3/4 code rate;
H₁₂=[1 0 0 1 1 0 0 1 0 1 1 0 0 1 1 0; 0 1 1 0 0 1 1 0 1 0 0 1 1 0 0 1], 7/8 code rate.

The first communication device can determine the first modulation and coding scheme based on Table 3 and the check matrix. For example, if the source distribution probability falls within the source distribution quantization interval 1, and the preset signal-to-noise ratio working point is SNR∈[9 dB, 15 dB), the first communication device can determine, by querying Table 3 based on the foregoing check matrix, that the first modulation and coding scheme includes the channel coding matrix H₂=[1 0 0 1 1 0 0 1; 0 1 1 0 0 1 1 0] and the code rate of the channel coding matrix is 3/4. The used modulation scheme is 16QAM.

It should be noted that different source distribution quantization intervals may correspond to different channel coding matrices or a same channel coding matrix. For example, H₄ and H₇ in the foregoing example are a same channel coding matrix. This is not limited in this embodiment. However, different channel state quantization intervals within a same source quantization distribution interval correspond to different channel coding matrices. For example, H₇, H₈, and H₉ in the foregoing example are different channel coding matrices.

In an embodiment, the mapping relationship between an MCS, a source distribution quantization interval, and a channel state quantization interval may be represented by adding a corresponding entry to an MCS table of an existing cellular system such as a 4G/5G system. Table 4 is an updated MCS table of the cellular system provided in this embodiment of this application. A first column to a third column in Table 4 correspond to the MCS table of the existing cellular system such as the 4G/5G system, and a fourth column in Table 4 is newly added source distribution information (for example, the source distribution probability) in this embodiment.

TABLE 4
An updated MCS table of a cellular system

| MCS | Modulation | | Source distribution |
|---|---|---|---|
| number | order | Code rate | quantization interval |
| 0 | QPSK | 1/2 | p₁∈[0.25, 0.75] |
| 1 | QPSK | 3/4 | p₁∈[0, 0.25)∪(0.75, 1] |
| 2 | 16QAM | 5/8 | p₁∈[0.25, 0.75] |
| 3 | 16QAM | 3/4 | p₁∈[0, 0.25)∪(0.75, 1] |
| 4 | 64QAM | 11/16 | p₁∈[0.25, 0.75] |
| 5 | 64QAM | 13/16 | p₁∈[0, 0.25)∪(0.75, 1] |
| 6 | 256QAM | 3/4 | p₁∈[0.25, 0.75] |
| 7 | 256QAM | 7/8 | p₁∈[0, 0.25)∪(0.75, 1] |

It can be learned that the source distribution information introduced in this embodiment may be compatible with the existing MCS table. To be specific, when the radio channel data processing method in this embodiment is applied to the existing cellular system such as the 4G/5G system, the existing MCS table may be updated to determine the modulation and coding scheme based on the source distribution information, and perform channel coding. This helps more conveniently improve coding performance of the transmit end of the coded data.

Optionally, based on the implementation shown in Table 4, the coding matrix may be further added to Table 4, to more specifically indicate the mapping relationship between an MCS, a source distribution quantization interval, and a channel state quantization interval. Table 5 is another updated MCS table of the cellular system provided in this embodiment of this application. A first column to a third column in Table 5 correspond to the MCS table of the existing cellular system such as the 4G/5G system, a fourth column is newly added source distribution information (for example, the source distribution probability) in this embodiment, and a fifth column is a newly added optional coding matrix in this embodiment.

TABLE 5
Another updated MCS table of a cellular system

| MCS | Modulation | | | Coding |
|---|---|---|---|---|
| number | order | Code rate | Source distribution interval | matrix |
| 0 | QPSK | 1/2 | p₁∈[0.25, 0.75] | C₁ |
| 1 | QPSK | 3/4 | p₁∈[0, 0.25)∪(0.75, 1] | C₂ |
| 2 | 16QAM | 5/8 | p₁∈[0.25, 0.75] | C₃ |
| 3 | 16QAM | 3/4 | p₁∈[0, 0.25)∪(0.75, 1] | C₄ |
| 4 | 64QAM | 11/16 | p₁∈[0.25, 0.75] | C₅ |
| 5 | 64QAM | 13/16 | p₁∈[0, 0.25)∪(0.75, 1] | C₆ |
| 6 | 256QAM | 3/4 | p₁∈[0.25, 0.75] | C₇ |
| 7 | 256QAM | 7/8 | p₁∈[0, 0.25)∪(0.75, 1] | C₈ |

It can be learned that different coding matrices may be used for MCSs with a same code rate. For example, code rates of an MCS 1 and an MCS 3 in Table 5 are both 3/4, but coding matrices C₂ and C₄ respectively used in the MCS 1 and the MCS 3 may be different. This is not limited in this embodiment.

In an example, if the first communication device does not perform simulation statistics on the correspondence between the source distribution, the channel state, and the modulation and coding scheme in advance, the first communication device can implement coding matrices with different code rates in a rate-compatible manner, for example, determine a corresponding channel coding matrix, modulation order, and first code rate based on the source distribution probability or the source entropy and the preset quantity of resources. The preset quantity of resources is a quantity of currently available resources of the system, and is converted into a symbol rate per second (R_{sym}). The first code rate is the code rate of the channel coding matrix. In other words, the first communication device collects statistics on probability distribution p₁ of “1” in data compressed from an upper layer (for example, an application layer) or original source data, and selects a corresponding MCS based on p₁ and the quantity of currently available resources of the system to perform data transmission.

In an embodiment, the first communication device determining the corresponding channel coding matrix, modulation order, and first code rate based on the source distribution probability or the source entropy and the preset quantity of resources includes the following steps:
determining the modulation order based on a preset signal-to-noise ratio working point;
determining a rate-compatible coding matrix set based on the source distribution probability or the source entropy, where the rate-compatible coding matrix set includes one or more coding matrices, and one coding matrix corresponds to one code rate;
determining the first code rate based on the preset quantity of resources, the modulation order, and a source bit rate; and
determining, from the rate-compatible coding matrix set based on the first code rate, a coding matrix corresponding to the first code rate as the channel coding matrix.

For example, the preset signal-to-noise ratio working point may be determined by the first communication device based on simulation statistics data, and is used to simulate a current channel state. When determining the modulation order, the first communication device may consider modulation orders such as BPSK, QPSK, 16QAM, and 64QAM, and the modulation orders respectively correspond to SNR intervals: S1, S2, S3, and S4. For example, the BPSK corresponds to the SNR interval S1, the QPSK corresponds to the SNR interval S2, the 16QAM corresponds to the SNR interval S3, and the 64QAM corresponds to the SNR interval S4. The first communication device determines an interval within which the preset signal-to-noise ratio working point falls, and selects a corresponding modulation order. For example, the preset signal-to-noise ratio working point falls within S3, and the first communication device determines that the modulation order is 16QAM.

Each source distribution interval corresponds to a group of channel coding matrices that may be compatible with different code rates. For example, the first communication device may implement rate compatibility of the coding matrices with different code rates in a rateless manner. For example, one source distribution probability corresponds to a group of rate-compatible channel coding matrices Cᵢ. It is assumed that the channel coding matrix Cᵢ may be compatible with a plurality of code rates Rᵢ, i=1, 2, . . . , N, and N is a positive integer. In this case, a corresponding rate-compatible coding matrix set may be selected based on the statistical source distribution probability.

Further, the first communication device calculates, based on the preset quantity of resources (converted into the symbol rate per second R_{sym}) and the selected modulation order (a quantity of bits is denoted as b_{Mod}), a bit rate R_{b}=R_{sym}*b_{Mod} at which transmission can be performed. Then the first communication device can calculate the first code rate R=R_{b_sec}/R_{b} based on the source bit rate (denoted as R_{b_src}). The first communication device determines, from the rate-compatible coding matrix set based on the first code rate, a coding matrix corresponding to the first code rate as the channel coding matrix.

In an embodiment, the first communication device determining the corresponding channel coding matrix, modulation order, and first code rate based on the source distribution probability or the source entropy and the preset quantity of resources includes the following steps:
determining a rate-compatible coding matrix set based on the source distribution probability or the source entropy, where the rate-compatible coding matrix set includes one or more coding matrices, and one coding matrix corresponds to one code rate;
determining a first relationship that is satisfied between the preset quantity of resources, the modulation order, the first code rate, and a source bit rate, where the first code rate is the code rate of the channel coding matrix;
determining a second relationship that is satisfied between the first code rate and a second code rate, where the second code rate is a maximum code rate of a coding matrix indicated by the source distribution information;
determining the modulation order based on the first relationship and the second relationship;
determining the first code rate based on the modulation order and the first relationship; and
determining, from the rate-compatible coding matrix set, a corresponding coding matrix as the corresponding channel coding matrix based on the first code rate.

For example, when the preset quantity of resources (converted into the symbol rate per second R_{sym}) is given, both the first code rate R (namely, a code rate) and the modulation order (a quantity of bits is denoted as b_{Mod}) may change. The first relationship that is satisfied between the preset quantity of resources, the modulation order, the first code rate, and the source bit rate (denoted as R_{b_src}) is R=R_{b_src}/(R_{sym}*b_{Mod}). To improve transmission reliability as much as possible, when it is ensured that the second relationship R≤Rₘₐₓ is satisfied between the first code rate and the second code rate, a value of b_{Mod} is as small as possible, that is, lower-order modulation is preferred. Rₘₐₓ is the maximum code rate of the channel coding matrix in the current source distribution. After the modulation order is determined, the first communication device calculates the code rate R of the coding matrix based on R=R_{b_src}/(R_{sym}*b_{Mod}), and finally obtains the corresponding channel coding matrix based on the source distribution.

After the first communication device determines the first modulation and coding scheme, the first communication device sends the uplink resource request message to the second communication device. The uplink resource request message includes the source distribution information and the first modulation and coding scheme. Correspondingly, the second communication device receives the uplink resource request message from the first communication device, and allocates the second modulation and coding scheme to the first communication device based on the source distribution information and the channel state. It may be understood that the first modulation and coding scheme may be the same as or different from the second modulation and coding scheme. The second communication device may determine the second modulation and coding scheme based on allocation of a network resource.

After allocating the second modulation and coding scheme to the first communication device, the second communication device may send the second modulation and coding scheme to the first communication device. Correspondingly, the first communication device receives the second modulation and coding scheme, and performs modulation and coding on the information bit based on the second modulation and coding scheme. A to-be-coded information bit is obtained by the first communication device. For example, the to-be-coded information bit may be an information bit that is received by the first communication device and that is from another communication device, or may be internally obtained by the first communication device (for example, obtained from data at the application layer). This is not limited in this embodiment.

Optionally, after the first communication device performs modulation and coding on the information bit based on the second modulation and coding scheme, the method may further include the following step.

S604: The first communication device sends the data stream to the second communication device. The data stream is determined by the first communication device by performing modulation and coding on the information bit based on the second modulation and coding scheme. Correspondingly, the second communication device receives the data stream from the first communication device.

S605: The second communication device performs demodulation and decoding on the received data stream based on the second modulation and coding scheme and the source distribution information.

For a specific process in which the first communication device performs modulation and coding on the information bit based on the second modulation and coding scheme, refer to an existing modulation and coding process. This is not limited in this embodiment. After performing modulation and coding on the information bit, the first communication device generates the corresponding data stream. Then the first communication device can send the data stream to the second communication device. Correspondingly, the second communication device receives the data stream. After receiving the data stream, the second communication device can perform demodulation and decoding on the data stream based on the second modulation and coding scheme and the source distribution information.

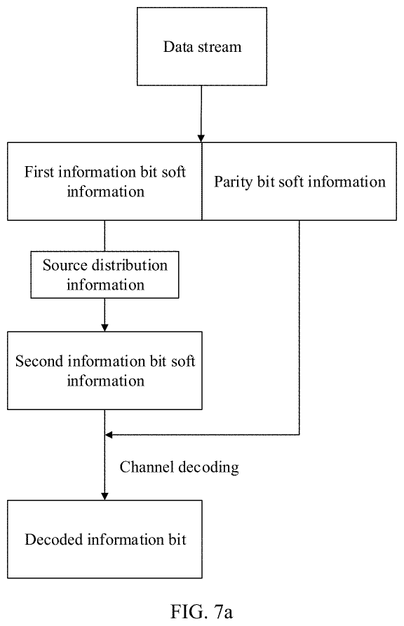

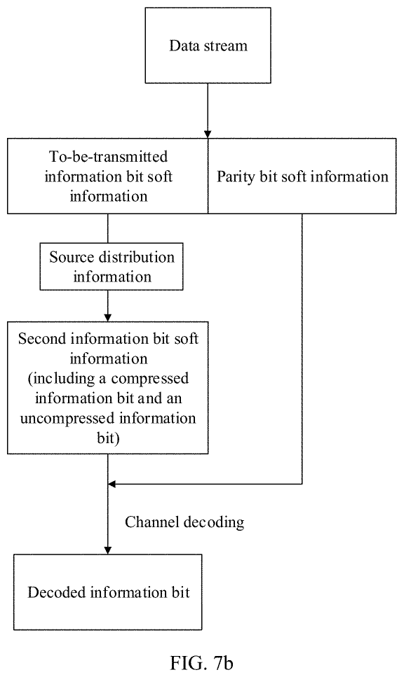

In this embodiment, when performing demodulation and decoding on the data stream, the second communication device can perform demodulation and decoding on the data stream based on the source distribution. This helps enhance decoding performance of the receive end of the coded data. For example, FIG. 7a is a schematic flowchart of a procedure in which the receive end of the coded data performs demodulation and decoding on the data stream according to an embodiment of this application. The second communication device first enhances first information bit soft information (namely, information bit soft information that corresponds to a bit location of the information bit and that is obtained after the data stream is demodulated) based on the source distribution information, to obtain second information bit soft information. Then channel decoding is completed based on the second information bit soft information and parity bit soft information, as shown in FIG. 7a.

The parity bit soft information is parity bit soft information that corresponds to a bit of a check bit and that is obtained after the data stream is demodulated. The second information bit soft information is obtained based on source distribution, for example, may be obtained according to the following formula 1:

LLR′=LLR+log(1−p₁)/p₁ (1)

LLR is a log likelihood ratio (log likelihood ratio), and represents the information bit soft information in this embodiment. In other words, LLR′ represents the second information bit soft information, LLR represents the first information bit soft information, and p₁ represents the source distribution probability. In this case, the second communication device can determine the second information bit soft information according to formula 1, and complete channel decoding based on the second information bit soft information and the parity bit soft information.

It may be understood that the coded data in a decoding procedure shown in FIG. 7a is uncompressed coded data. Optionally, if the coded data is to-be-compressed coded data, the decoding procedure of the second communication device further includes a process of decoding compressed coded data. For example, FIG. 7b is a schematic flowchart of another procedure in which the receive end of the coded data performs demodulation and decoding on the data stream according to an embodiment of this application.

The second communication device first enhances to-be-transmitted information bit soft information (namely, information bit soft information that corresponds to a bit location of a to-be-transmitted information bit and is obtained after the data stream is demodulated) based on the source distribution information, to obtain second information bit soft information. The second information bit soft information shown in FIG. 7b includes compressed information bit soft information and uncompressed information bit soft information. In the example shown in FIG. 7b, the compressed information bit soft information and the uncompressed information bit soft information may be respectively obtained according to formula 2 and formula 3:

LLR″=log(1−p₁)/p₁ (2)

LLR′=LLR+log(1−p₁)/p₁ (3)

LLR′ represents uncompressed second information bit soft information, LLR″ represents compressed second information bit soft information, LLR represents first information bit soft information, and p₁ represents the source distribution probability. In this case, the second communication device can determine the second information bit soft information according to formula 2 and formula 3, and complete channel decoding based on the second information bit soft information and parity bit soft information, that is, obtain a decoded information bit through decoding.

The transmit end (for example, the first communication device) of the coded data can compress the information bit in an information bit puncturing manner. For example, the first communication device divides the to-be-transmitted information bit into K bit locations of the information bit and M bit locations of the check bit, punctures the information bits, and reserves K′ bit locations of the information bit, and 0≤K′<K. The information bit puncturing manner may include but is not limited to puncturing several consecutive bit locations of the information bit at a header or a tail or in the middle, or may be designing one or more inconsecutive puncturing patterns. This is not limited in this embodiment. Optionally, after determining a puncturing pattern to be used, the first communication device can add information corresponding to the puncturing pattern to the uplink resource request message, so that the transmit end and receive end of the coded data agree on the puncturing pattern to be used in advance. It may be understood that an actual code rate in this scenario is K/(K′+M) and the code rate can be flexibly adjusted by adjusting K′. This helps achieve different source compression and channel protection effect.

This embodiment of this application provides the radio channel data processing method. The method can be implemented through interaction between the first communication device and the second communication device. The first communication device sends the uplink resource request message to the second communication device. The uplink resource request message includes the source distribution information and the first modulation and coding scheme. The first modulation and coding scheme is determined based on the source distribution information. The first communication device receives the uplink resource allocation message from the second communication device. The uplink resource allocation message includes the second modulation and coding scheme. The second modulation and coding scheme is the modulation and coding scheme allocated by the second communication device to the first communication device. The first communication device performs modulation and coding on the information bit based on the second modulation and coding scheme. It can be learned that the first communication device can determine the first modulation and coding scheme based on the source distribution information. This helps improve coding performance of the transmit end of the coded data.

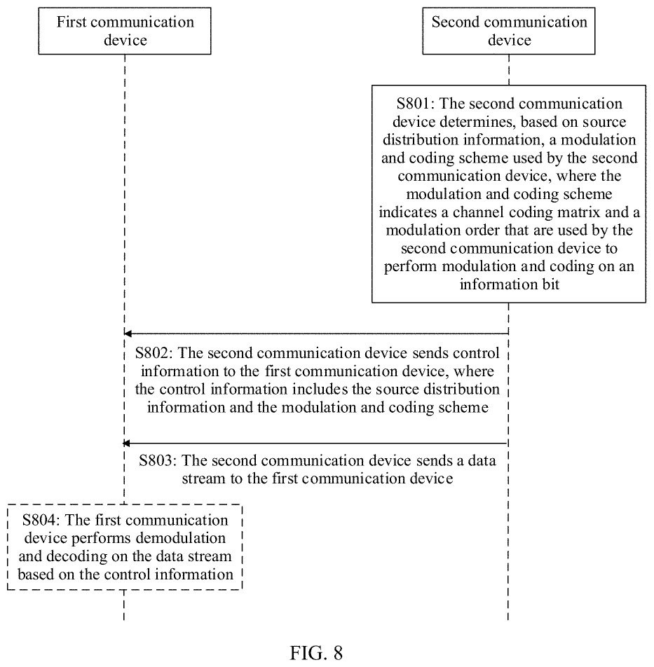

FIG. 8 is a schematic flowchart of another radio channel data processing method according to an embodiment of this application. The radio channel data processing method may be implemented through interaction between a first communication device and a second communication device. In this embodiment, the second communication device is a transmit end of coded data, and the first communication device is a receive end of the coded data. The method may include the following steps.

S801: The second communication device determines, based on source distribution information, a modulation and coding scheme used by the second communication device. The modulation and coding scheme indicates a channel coding matrix and a modulation order that are used by the second communication device to perform modulation and coding on an information bit.

S802: The second communication device sends control information to the first communication device. The control information includes the source distribution information and the modulation and coding scheme. Correspondingly, the first communication device receives the control information from the second communication device.

S803: The second communication device sends a data stream to the first communication device. Correspondingly, the first communication device receives the data stream from the second communication device.

As the transmit end of the coded data, the second communication device may determine the modulation and coding scheme based on the source distribution information. The source distribution information may include but is not limited to a source distribution probability, a source entropy, a preset quantity of resources, or the like. For detailed descriptions of the source distribution information, refer to the detailed descriptions of the source distribution information in the embodiment shown in FIG. 6. Details are not described herein again.

Further, the second communication device may determine the modulation and coding scheme based on the source distribution information and channel state information. That is, both a channel state and source distribution are considered in the modulation and coding scheme described in this embodiment. This helps enhance coding performance. Specifically, the second communication device may alternatively determine the modulation and coding scheme based on a correspondence (shown in Table 1 to Table 3) between the source distribution, the channel state, and the modulation and coding scheme. For a specific determining manner, refer to detailed descriptions in the embodiment shown in FIG. 6. Details are not described herein again. Optionally, if the second communication device does not perform simulation statistics on the correspondence between the source distribution, the channel state, and the modulation and coding scheme in advance, the second communication device may implement coding matrices with different code rates in a rate-compatible manner. For a specific implementation, refer to detailed descriptions in the embodiment shown in FIG. 6. Details are not described herein again.

It can be learned that, compared with the transmit end of the coded data (that is, the first communication device) in the embodiment shown in FIG. 6, the transmit end of the coded data (that is, the second communication device) in this embodiment, as a network device (for example, a base station), can directly determine the modulation and coding scheme used by the transmit end of the coded data, and does not need to reconfirm, with the first communication device, whether the modulation and coding scheme is used.

For a specific process in which the second communication device performs modulation and coding on the information bit based on the modulation and coding scheme, refer to an existing modulation and coding process. This is not limited in this embodiment. After performing modulation and coding on the information bit, the second communication device generates the corresponding data stream, and sends the data stream to the first communication device.

Optionally, after the second communication device sends the data stream to the first communication device, the method may further include the following step:

S804: The first communication device performs demodulation and decoding on the data stream based on the control information.

When performing demodulation and decoding on the data stream, the first communication device can perform demodulation and decoding on the data stream based on the source distribution. This helps enhance decoding performance of the receive end of the coded data. For a specific decoding manner, refer to detailed descriptions in embodiments shown in FIG. 7a and FIG. 7b. Details are not described herein again.

This embodiment of this application provides the radio channel data processing method. The method can be implemented through interaction between the first communication device and the second communication device. The second communication device determines, based on the source distribution information, the modulation and coding scheme used by the second communication device. The modulation and coding scheme indicates the channel coding matrix and the modulation order that are used by the second communication device to perform modulation and coding on the information bit. The second communication device sends the control information to the first communication device. The control information includes the source distribution information and the modulation and coding scheme. The second communication device sends the data stream to the first communication device. The data stream is obtained by the second communication device by performing modulation and coding on the information bit based on the modulation and coding scheme. It can be learned that the second communication device can determine, based on the source distribution information, the modulation and coding scheme used by the second communication device, and perform modulation and coding on the information bit based on the modulation and coding scheme to obtain the corresponding data stream. This helps improve coding performance of the transmit end of coded data.

The following describes in detail a communication mechanism corresponding to the radio channel data processing method in embodiments of this application.

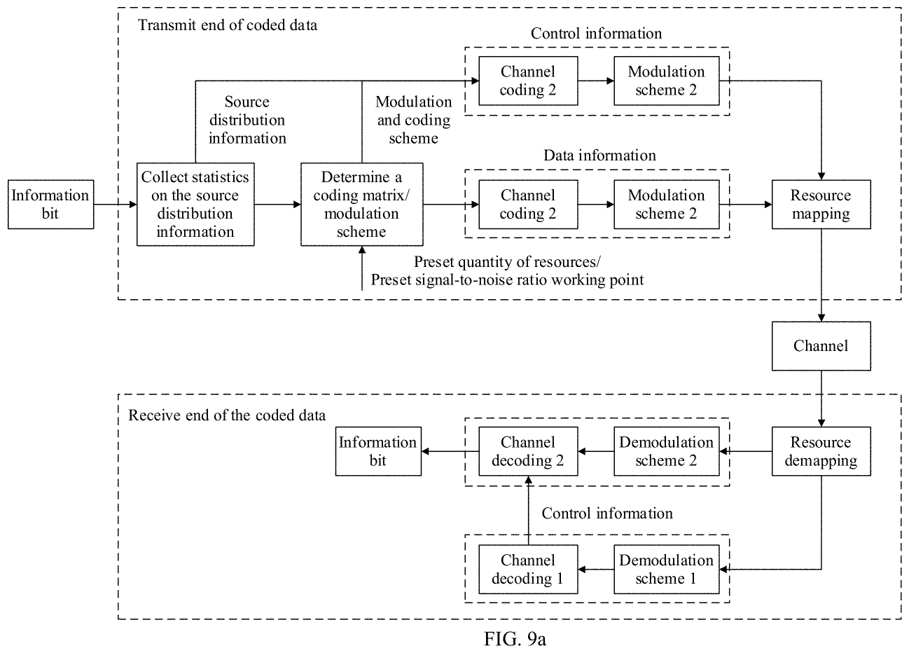

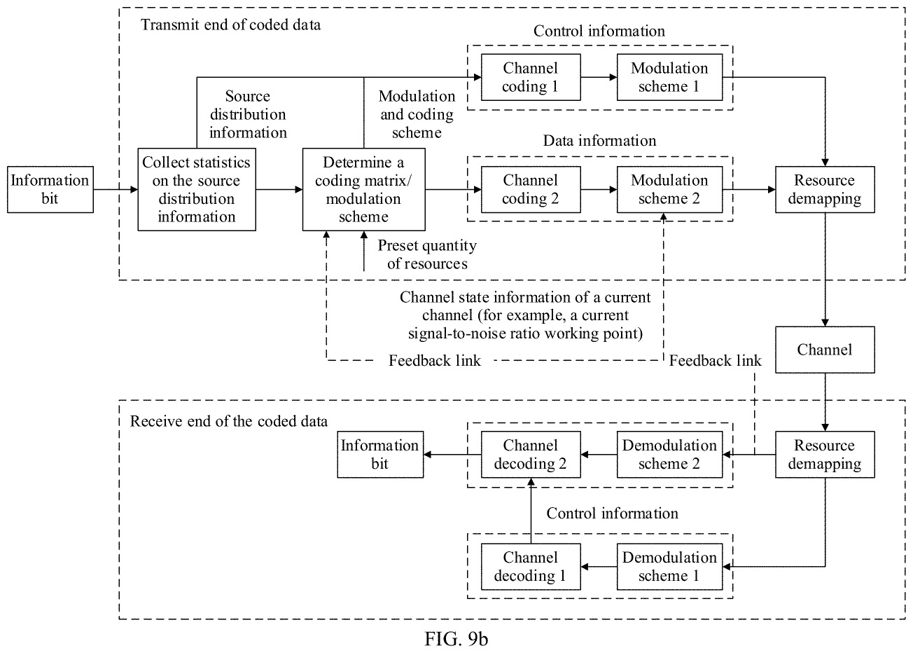

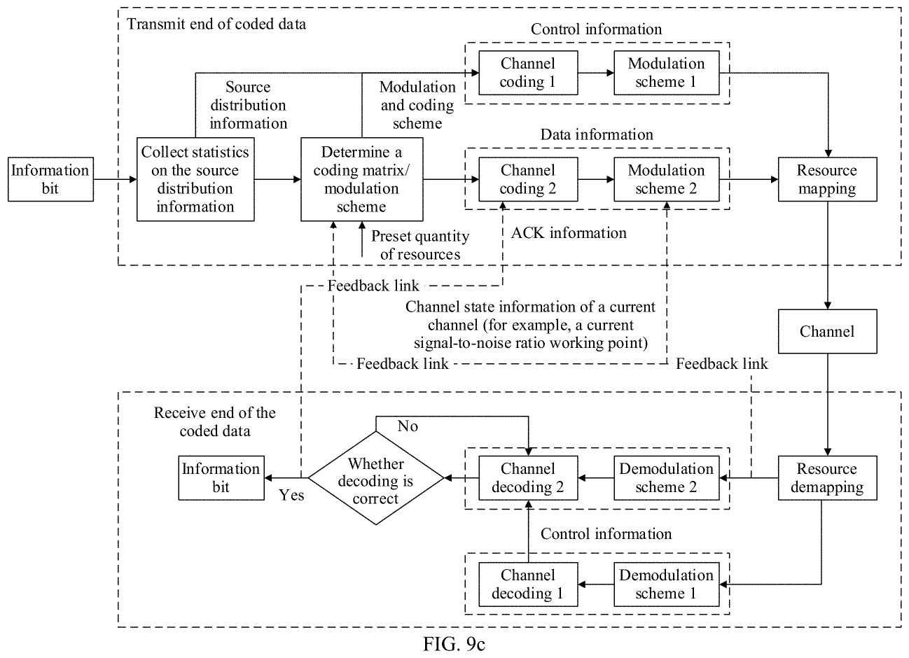

In an example, FIG. 9a is a schematic flowchart of a radio channel data processing method in a non-feedback communication mechanism according to an embodiment of this application. To be specific, a receive end of coded data in the non-feedback communication mechanism does not feed back related information (for example, a current channel state) to a transmit end of the coded data, and the transmit end of the coded data determines a modulation and coding scheme only based on information such as source distribution information, a preset quantity of resources, and a preset signal-to-noise ratio working point.

In an example, FIG. 9b is a schematic flowchart of a radio channel data processing method in a weak-feedback communication mechanism according to an embodiment of this application. As shown in FIG. 9b, a receive end of coded data in the weak-feedback communication mechanism may feed back channel state information (for example, information such as an SNR working point) of a current channel to a transmit end of the coded data over a feedback link. After receiving the feedback information, the transmit end of the coded data can determine a modulation and coding scheme based on information such as source distribution information, a preset quantity of resources, and the signal-to-noise ratio working point of the current channel.

It can be learned that the modulation and coding scheme determined by the transmit end of the coded data in the weak-feedback communication mechanism shown in FIG. 9b can better match current source distribution and the current channel state than that in the non-feedback communication mechanism shown in FIG. 9a.

In an example, FIG. 9c is a schematic flowchart of a radio channel data processing method in a strong-feedback communication mechanism according to an embodiment of this application. As shown in FIG. 9c, a receive end of coded data in the strong-feedback communication mechanism may feed back channel state information (for example, information such as an SNR working point) of a current channel and acknowledgement (acknowledgement, ACK) information to a transmit end of the coded data over a feedback link.

For example, the receive end of the coded data needs to feed back the SNR/ACK information of the current channel to the transmit end of the coded data over the feedback link. The transmit end of the coded data selects an MCS based on source distribution information, a preset quantity of resources, and a current SNR working point, and supports working modes such as a rateless (Rateless) working mode and a hybrid automatic repeat request (HARQ) mode based on the ACK information, NACK information, or other information. For example, in the rateless working mode, the transmit end of the coded data keeps sending check bits coded by using a rate-compatible coding matrix until a minimum code rate is reached or the ACK information fed back is received.

It can be learned that the modulation and coding scheme determined by the transmit end of the coded data in the strong-feedback communication mechanism shown in FIG. 9c can better match current source distribution and the current channel state than that in the weak-feedback communication mechanism shown in FIG. 9b. In addition, the ACK information can be introduced, to improve decoding performance of the receive end of the coded data.

In conclusion, the transmit end of the coded data shown in FIG. 9a to FIG. 9c may be the first communication device in the embodiment shown in FIG. 6, or may be the second communication device in the embodiment shown in FIG. 8. To be specific, when performing the radio channel data processing method, the first communication device shown in FIG. 6 and the second communication device shown in FIG. 8 can perform related steps performed by the transmit end of the coded data shown in FIG. 9a to FIG. 9c. For example, the transmit end of the coded data collects statistics on the source distribution information, and determines the modulation and coding scheme based on the information such as the source distribution information and the preset quantity of resources/signal-to-noise ratio working point.

Correspondingly, the receive end of the coded data shown in FIG. 9a to FIG. 9c may be the second communication device in the embodiment shown in FIG. 6, or may be the first communication device in the embodiment shown in FIG. 8. To be specific, when performing the radio channel data processing method, the second communication device shown in FIG. 6 and the first communication device shown in FIG. 8 can perform related steps performed by the receive end of the coded data shown in FIG. 9a to FIG. 9c.

The control information shown in FIG. 9a to FIG. 9c may be transmitted in a high-reliability manner (for example, 1/2 code rate+BPSK). A modulation and coding scheme used in the control information may be preset, and may be different from a modulation and coding scheme used in an information bit. In other words, both the transmit end of the coded data and the receive end of the coded data know the modulation and coding scheme used in the control information. The modulation and coding scheme used in the control information may generally use a low-order code rate, and only correctness of transmission of the control information needs to be ensured. For example, as shown in FIG. 9a to FIG. 9c, channel coding 1 and a modulation scheme 1 may be different from channel coding 2 and a modulation scheme 2. The channel coding 1 represents a channel coding matrix and a code rate that are used in the control information, and the modulation scheme 1 represents a channel coding matrix and a code rate that are used in the information bit. Correspondingly, channel decoding 1 represents a decoding scheme determined based on the channel coding matrix and the code rate that are used in the control information, and a demodulation scheme 1 represents a demodulation scheme determined based on the channel coding matrix and the code rate that are used in the information bit.

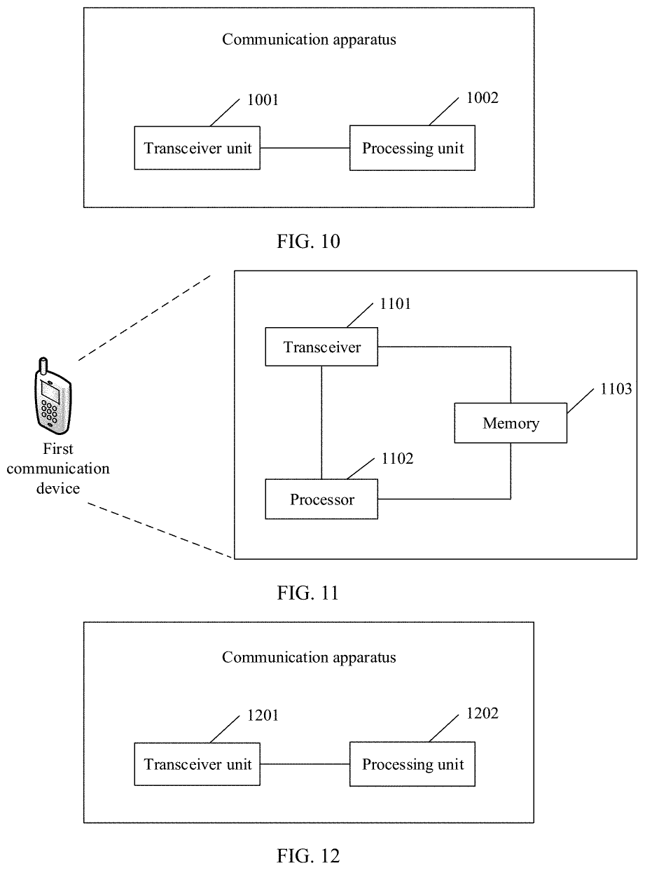

The following describes in detail communication apparatuses and communication devices provided in embodiments of this application with reference to FIG. 10 to FIG. 17.

An embodiment of this application provides a communication apparatus. As shown in FIG. 10, the communication apparatus is configured to implement the method performed by a first communication device in the embodiment shown in FIG. 6, and specifically includes a transceiver unit 1001 and a processing unit 1002.

The transceiver unit 1001 is configured to send an uplink resource request message to a second communication device. The uplink resource request message includes source distribution information and a first modulation and coding scheme, and the first modulation and coding scheme is determined based on the source distribution information.

The transceiver unit 1001 is further configured to receive an uplink resource allocation message from the second communication device. The uplink resource allocation message includes a second modulation and coding scheme, and the second modulation and coding scheme is a modulation and coding scheme allocated by the second communication device to the first communication device.

The processing unit 1002 is configured to perform modulation and coding on an information bit based on the second modulation and coding scheme.

In an embodiment, the processing unit 1002 is further configured to:
obtain a plurality of source distribution quantization intervals; and
determine, for one source distribution quantization interval in the plurality of source distribution quantization intervals, a channel state quantization interval, and a modulation and coding scheme corresponding to the source distribution quantization interval, where the source distribution quantization interval corresponds to one or more channel state quantization intervals, the source distribution quantization interval corresponds to one or more modulation and coding schemes, and one channel state quantization interval corresponds to one modulation and coding scheme.

In an embodiment, the processing unit 1002 is further configured to:
determine a corresponding source distribution quantization interval based on a source distribution probability or a source entropy;
determine a corresponding channel state quantization interval based on a preset signal-to-noise ratio working point; and
determine a corresponding channel coding matrix and modulation order based on the corresponding source distribution quantization interval and the corresponding channel state quantization interval.

In an embodiment, the processing unit 1002 is further configured to:
determine a corresponding channel coding matrix, modulation order, and first code rate based on a source distribution probability or a source entropy and a preset quantity of resources, where the first code rate is a code rate of the corresponding channel coding matrix.

In an embodiment, that the processing unit 1002 is configured to determine a corresponding channel coding matrix, modulation order, and first code rate based on a source distribution probability or a source entropy and a preset quantity of resources is specifically configured to:
determine the modulation order based on a preset signal-to-noise ratio working point;
determine a rate-compatible coding matrix set based on the source distribution probability or the source entropy, where the rate-compatible coding matrix set includes one or more coding matrices, and one coding matrix corresponds to one code rate;
determine the first code rate based on the preset quantity of resources, the modulation order, and a source bit rate; and
determine, from the rate-compatible coding matrix set based on the first code rate, a coding matrix corresponding to the first code rate as the corresponding channel coding matrix.

In an embodiment, that the processing unit 1002 is configured to determine a corresponding channel coding matrix, modulation order, and first code rate based on a source distribution probability or a source entropy and a preset quantity of resources is specifically configured to:
determine a rate-compatible coding matrix set based on the source distribution probability or the source entropy, where the rate-compatible coding matrix set includes one or more coding matrices, and one coding matrix corresponds to one code rate;
determine a first relationship that is satisfied between the preset quantity of resources, the modulation order, the first code rate, and a source bit rate, where the first code rate is the code rate of the channel coding matrix;
determine a second relationship that is satisfied between the first code rate and a second code rate, where the second code rate is a maximum code rate of a coding matrix indicated by the source distribution information;
determine the modulation order based on the first relationship and the second relationship;
determine the first code rate based on the modulation order and the first relationship; and
determine, from the rate-compatible coding matrix set, a corresponding coding matrix as the corresponding channel coding matrix based on the first code rate.

In an embodiment, the transceiver unit 1001 is further configured to receive first feedback information from the second communication device. The first feedback information includes a signal-to-noise ratio of a channel used by the first communication device to send a data stream to the second communication device.

In an embodiment, the transceiver unit 1001 is further configured to receive second feedback information from the second communication device. The second feedback information indicates correct decoding of the second communication device.

In an embodiment, related functions implemented by the units in FIG. 10 may be implemented by using a transceiver and a processor. FIG. 11 is a schematic diagram of a structure of a first communication device according to an embodiment of this application. The first communication device may be a device (for example, a chip) that has a radio channel data processing function in the embodiment shown in FIG. 6. The first communication device may include a transceiver 1101, at least one processor 1102, and a memory 1103. The transceiver 1101, the processor 1102, and the memory 1103 may be connected to each other through one or more communication buses, or may be connected to each other in another manner.

The transceiver 1101 may be configured to send data or receive data. It may be understood that the transceiver 1101 is a general term, and may include a receiver and a transmitter. For example, the transmitter is configured to send an uplink resource request message to a second communication device. For another example, the receiver is configured to receive an uplink resource allocation message from a second communication device.

The processor 1102 may be configured to process data of the first communication device, or process data to be sent by the transceiver 1101. The processor 1102 may include one or more processors. For example, the processor 1102 may be one or more central processing units (CPU), one or more network processors (NP), one or more hardware chips, or any combination thereof. When the processor 1102 is one CPU, the CPU may be a single-core CPU or may be a multi-core CPU.

The memory 1103 is configured to store program code and the like. The memory 1103 may include a volatile memory, for example, a random access memory (RAM). The memory 1103 may also include a non-volatile memory, for example, a read-only memory (ROM), a flash memory, a hard disk drive (HDD), or a solid-state drive (SSD). The memory 1103 may further include a combination of the foregoing types of memories.

The processor 1102 and the memory 1103 may be coupled through an interface, or may be integrated together. This is not limited in this embodiment.

The transceiver 1101 and the processor 1102 may be used in the radio channel data processing method in the embodiment shown in FIG. 6. Specific embodiments are as follows:

The transceiver 1101 is configured to send an uplink resource request message to a second communication device. The uplink resource request message includes source distribution information and a first modulation and coding scheme, and the first modulation and coding scheme is determined based on the source distribution information.

The transceiver 1101 is further configured to receive an uplink resource allocation message from the second communication device. The uplink resource allocation message includes a second modulation and coding scheme, and the second modulation and coding scheme is a modulation and coding scheme allocated by the second communication device to the first communication device.

The processor 1102 is configured to perform modulation and coding on an information bit based on the second modulation and coding scheme.

In an embodiment, the processor 1102 is further configured to:
obtain a plurality of source distribution quantization intervals; and
determine, for one source distribution quantization interval in the plurality of source distribution quantization intervals, a channel state quantization interval and a modulation and coding scheme corresponding to the source distribution quantization interval, where the source distribution quantization interval corresponds to one or more channel state quantization intervals, the source distribution quantization interval corresponds to one or more modulation and coding schemes, and one channel state quantization interval corresponds to one modulation and coding scheme.

In an embodiment, the processor 1102 is further configured to:
determine a corresponding source distribution quantization interval based on a source distribution probability or a source entropy;
determine a corresponding channel state quantization interval based on a preset signal-to-noise ratio working point; and
determine a corresponding channel coding matrix and modulation order based on the corresponding source distribution quantization interval and the corresponding channel state quantization interval.

In an embodiment, the processor 1102 is further configured to:
determine a corresponding channel coding matrix, modulation order, and first code rate based on a source distribution probability or a source entropy and a preset quantity of resources, where the first code rate is a code rate of the corresponding channel coding matrix.

In an embodiment, that the processor 1102 is configured to determine a corresponding channel coding matrix, modulation order, and first code rate based on a source distribution probability or a source entropy and a preset quantity of resources is specifically configured to:
determine the modulation order based on a preset signal-to-noise ratio working point;
determine a rate-compatible coding matrix set based on the source distribution probability or the source entropy, where the rate-compatible coding matrix set includes one or more coding matrices, and one coding matrix corresponds to one code rate;
determine the first code rate based on the preset quantity of resources, the modulation order, and a source bit rate; and
determine, from the rate-compatible coding matrix set based on the first code rate, a coding matrix corresponding to the first code rate as the corresponding channel coding matrix.

In an embodiment, that the processor 1102 is configured to determine a corresponding channel coding matrix, modulation order, and first code rate based on a source distribution probability or a source entropy and a preset quantity of resources is specifically configured to:
determine a rate-compatible coding matrix set based on the source distribution probability or the source entropy, where the rate-compatible coding matrix set includes one or more coding matrices, and one coding matrix corresponds to one code rate;
determine a first relationship that is satisfied between the preset quantity of resources, the modulation order, the first code rate, and a source bit rate, where the first code rate is the code rate of the channel coding matrix;
determine a second relationship that is satisfied between the first code rate and a second code rate, where the second code rate is a maximum code rate of a coding matrix indicated by the source distribution information;
determine the modulation order based on the first relationship and the second relationship;
determine the first code rate based on the modulation order and the first relationship; and
determine, from the rate-compatible coding matrix set, a corresponding coding matrix as the corresponding channel coding matrix based on the first code rate.

In an embodiment, the transceiver 1101 is further configured to receive first feedback information from the second communication device. The first feedback information includes a signal-to-noise ratio of a channel used by the first communication device to send a data stream to the second communication device.

In an embodiment, the transceiver 1101 is further configured to receive second feedback information from the second communication device. The second feedback information indicates correct decoding of the second communication device.

An embodiment of this application provides a communication apparatus. As shown in FIG. 12, the communication apparatus is configured to implement the method performed by a second communication device in the embodiment shown in FIG. 6, and specifically includes:
a transceiver unit 1201, configured to receive an uplink resource request message from a first communication device, where the uplink resource request message includes source distribution information and a first modulation and coding scheme, and the first modulation and coding scheme is determined based on the source distribution information.

The transceiver unit 1201 is further configured to send an uplink resource allocation message to the first communication device. The uplink resource allocation message includes a second modulation and coding scheme, and the second modulation and coding scheme is a modulation and coding scheme allocated by the second communication device to the first communication device.

In an embodiment, the transceiver unit 1201 is further configured to receive a data stream from the first communication device. The data stream is determined by the first communication device by performing modulation and coding on an information bit based on the second modulation and coding scheme.

The communication apparatus further includes a processing unit 1202. The processing unit 1202 is configured to perform demodulation and decoding on the data stream based on the second modulation and coding scheme and the source distribution information.

In an embodiment, that the processing unit 1202 is configured to perform demodulation and decoding on the data stream based on the second modulation and coding scheme and the source distribution information is specifically configured to:
demodulate the data stream based on a modulation order indicated by the modulation and coding scheme; and
obtain the information bit through decoding based on the source distribution information and a channel coding matrix indicated by the modulation and coding scheme.

In an embodiment, that the processing unit 1202 is configured to demodulate the data stream based on a modulation order indicated by the modulation and coding scheme is specifically configured to:
obtain first information bit soft information and parity bit soft information in the data stream through demodulating.

That the processing unit 1202 is configured to obtain the information bit through decoding based on the source distribution information and a channel coding matrix indicated by the modulation and coding scheme is specifically configured to:
determine second information bit soft information based on the source distribution information; and
obtain the information bit through decoding based on the second information bit soft information and the parity bit soft information.

In an embodiment, the transceiver unit 1201 is further configured to send first feedback information to the first communication device. The first feedback information includes a signal-to-noise ratio of a channel used by the first communication device to send the data stream to the second communication device.

In an embodiment, the transceiver unit 1201 is further configured to send second feedback information to the first communication device. The second feedback information indicates correct decoding of the second communication device.

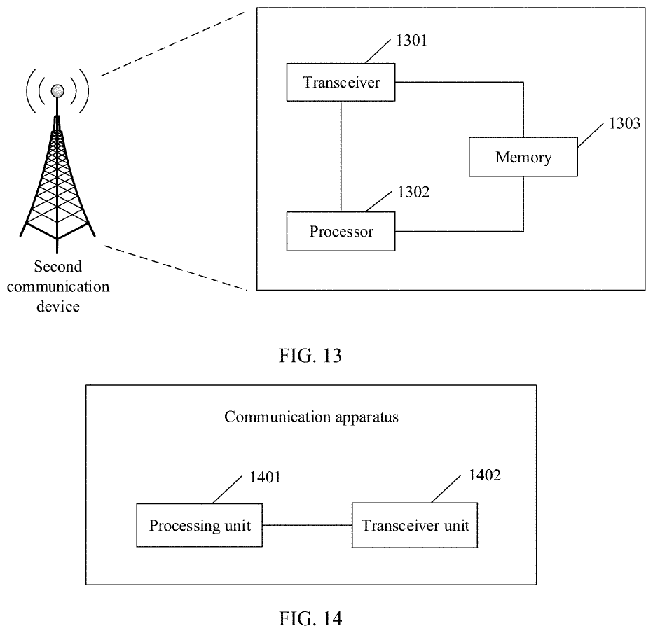

In an embodiment, related functions implemented by the units in FIG. 12 may be implemented by using a transceiver and a processor. FIG. 13 is a schematic diagram of a structure of a second communication device according to an embodiment of this application. The second communication device may be a device (for example, a chip) that has a radio channel data processing function in the embodiment shown in FIG. 6. The second communication device may include a transceiver 1301, at least one processor 1302, and a memory 1303. The transceiver 1301, the processor 1302, and the memory 1303 may be connected to each other through one or more communication buses, or may be connected to each other in another manner.

The transceiver 1301 may be configured to send data or receive data. It may be understood that the transceiver 1301 is a general term, and may include a receiver and a transmitter. For example, the receiver is configured to receive an uplink resource request message from a first communication device. For another example, the transmitter is configured to send an uplink resource allocation message to a first communication device.

The processor 1302 may be configured to process data of the second communication device, or process data to be sent by the transceiver 1301. The processor 1302 may include one or more processors. For example, the processor 1302 may be one or more central processing units (CPU), one or more network processors (NP), one or more hardware chips, or any combination thereof. When the processor 1302 is one CPU, the CPU may be a single-core CPU or may be a multi-core CPU.

The memory 1303 is configured to store program code and the like. The memory 1303 may include a volatile memory, for example, a random access memory (RAM). The memory 1303 may also include a non-volatile memory, for example, a read-only memory (ROM), a flash memory, a hard disk drive (HDD), or a solid-state drive (SSD). The memory 1303 may further include a combination of the foregoing types of memories.

The processor 1302 and the memory 1303 may be coupled through an interface, or may be integrated together. This is not limited in this embodiment.

The transceiver 1301 and the processor 1302 may be configured to implement the radio channel data processing method in the embodiment shown in FIG. 6. Specific implementations are as follows:

The transceiver 1301 is configured to receive an uplink resource request message from a first communication device. The uplink resource request message includes source distribution information and a first modulation and coding scheme, and the first modulation and coding scheme is determined based on the source distribution information.

The transceiver 1301 is further configured to send an uplink resource allocation message to the first communication device. The uplink resource allocation message includes a second modulation and coding scheme, and the second modulation and coding scheme is a modulation and coding scheme allocated by the second communication device to the first communication device.

In an embodiment, the transceiver 1301 is further configured to receive a data stream from the first communication device. The data stream is determined by the first communication device by performing modulation and coding on an information bit based on the second modulation and coding scheme.

The processor 1302 is configured to perform demodulation and decoding on the data stream based on the second modulation and coding scheme and the source distribution information.

In an embodiment, that the processor 1302 is configured to perform demodulation and decoding on the data stream based on the second modulation and coding scheme and the source distribution information is specifically configured to:
demodulate the data stream based on a modulation order indicated by the modulation and coding scheme; and
obtain the information bit through decoding based on the source distribution information and a channel coding matrix indicated by the modulation and coding scheme.

In an embodiment, that the processor 1302 is configured to demodulate the data stream based on a modulation order indicated by the modulation and coding scheme is specifically configured to:
obtain first information bit soft information and parity bit soft information in the data stream through demodulating.

That the processor 1302 is configured to obtain the information bit through decoding based on the source distribution information and a channel coding matrix indicated by the modulation and coding scheme is specifically configured to:
determine second information bit soft information based on the source distribution information; and
obtain the information bit through decoding based on the second information bit soft information and the parity bit soft information.

In an embodiment, the transceiver 1301 is further configured to send first feedback information to the first communication device. The first feedback information includes a signal-to-noise ratio of a channel used by the first communication device to send the data stream to the second communication device.

In an embodiment, the transceiver 1301 is further configured to send second feedback information to the first communication device. The second feedback information indicates correct decoding of the second communication device.

An embodiment of this application provides a communication apparatus. As shown in FIG. 14, the communication apparatus is configured to implement the method performed by a second communication device in the embodiment shown in FIG. 8, and specifically includes a processing unit 1401 and a transceiver unit 1402.

The processing unit 1401 is configured to determine, based on source distribution information, a modulation and coding scheme used by the second communication device.

The transceiver unit 1402 is further configured to send control information to a first communication device. The control information includes the source distribution information and the modulation and coding scheme.

The transceiver unit 1402 is further configured to send a data stream to the first communication device. The data stream is obtained by the second communication device by performing modulation and coding on an information bit based on the modulation and coding scheme.

In an embodiment, the processing unit 1401 is further configured to:
obtain a plurality of source distribution quantization intervals; and
determine, for one source distribution quantization interval in the plurality of source distribution quantization intervals, a channel state quantization interval and a modulation and coding scheme corresponding to the source distribution quantization interval, where the source distribution quantization interval corresponds to one or more channel state quantization intervals, the source distribution quantization interval corresponds to one or more modulation and coding schemes, and one channel state quantization interval corresponds to one modulation and coding scheme.

In an embodiment, that the processing unit 1401 is configured to determine, based on source distribution information, a modulation and coding scheme used by the second communication device is specifically configured to:
determine a corresponding source distribution quantization interval based on a source distribution probability or a source entropy;
determine a corresponding channel state quantization interval based on a preset signal-to-noise ratio working point; and
determine a corresponding channel coding matrix and modulation order based on the corresponding source distribution quantization interval and the corresponding channel state quantization interval.

In an embodiment, that the processing unit 1401 is configured to determine, based on source distribution information, a modulation and coding scheme used by the second communication device is specifically configured to:
determine a corresponding channel coding matrix, modulation order, and first code rate based on a source distribution probability or a source entropy and a preset quantity of resources, where the first code rate is a code rate of the channel coding matrix.

In an embodiment, that the processing unit 1401 is configured to determine a corresponding channel coding matrix, modulation order, and first code rate based on a source distribution probability or a source entropy and a preset quantity of resources is specifically configured to:
determine the modulation order based on a preset signal-to-noise ratio working point;
determine a rate-compatible coding matrix set based on the source distribution probability or the source entropy, where the rate-compatible coding matrix set includes one or more coding matrices, and one coding matrix corresponds to one code rate;
determine the first code rate based on the preset quantity of resources, the modulation order, and a source bit rate; and
determine, from the rate-compatible coding matrix set based on the first code rate, a coding matrix corresponding to the first code rate as the channel coding matrix.

In an embodiment, that the processing unit 1401 is configured to determine a corresponding channel coding matrix, modulation order, and first code rate based on a source distribution probability or a source entropy and a preset quantity of resources is specifically configured to:
determine a rate-compatible coding matrix set based on the source distribution probability or the source entropy, where the rate-compatible coding matrix set includes one or more coding matrices, and one coding matrix corresponds to one code rate;
determine a first relationship that is satisfied between the preset quantity of resources, the modulation order, the first code rate, and a source bit rate, where the first code rate is the code rate of the channel coding matrix;
determine a second relationship that is satisfied between the first code rate and a second code rate, where the second code rate is a maximum code rate of a coding matrix indicated by the source distribution information;
determine the modulation order based on the first relationship and the second relationship;
determine the first code rate based on the modulation order and the first relationship; and
determine, from the rate-compatible coding matrix set, a corresponding coding matrix as the corresponding channel coding matrix based on the first code rate.

In an embodiment, the transceiver unit 1402 is further configured to send first feedback information to the first communication device. The first feedback information includes a signal-to-noise ratio of a channel used by the first communication device to send the data stream to the second communication device.

In an embodiment, the transceiver unit 1402 is further configured to send second feedback information to the first communication device. The second feedback information indicates correct decoding of the second communication device.

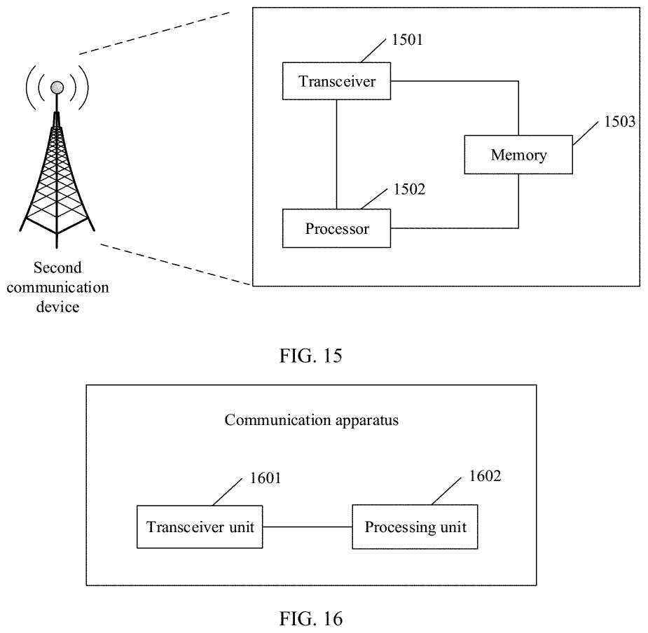

In an embodiment, related functions implemented by the units in FIG. 14 may be implemented by using a transceiver and a processor. FIG. 15 is a schematic diagram of a structure of another second communication device according to an embodiment of this application. The second communication device may be a device (for example, a chip) that has a radio channel data processing function in the embodiment shown in FIG. 8. The second communication device may include a transceiver 1501, at least one processor 1502, and a memory 1503. The transceiver 1501, the processor 1502, and the memory 1503 may be connected to each other through one or more communication buses, or may be connected to each other in another manner.

The transceiver 1501 may be configured to send data or receive data. It may be understood that the transceiver 1501 is a general term, and may include a receiver and a transmitter. For example, the transmitter is configured to send a data stream to a first communication device.

The processor 1502 may be configured to process data of the second communication device, or process data to be sent by the transceiver 1501. The processor 1502 may include one or more processors. For example, the processor 1502 may be one or more central processing units (CPU), one or more network processors (NP), one or more hardware chips, or any combination thereof. When the processor 1502 is one CPU, the CPU may be a single-core CPU or may be a multi-core CPU.

The memory 1503 is configured to store program code and the like. The memory 1503 may include a volatile memory, for example, a random access memory (RAM). The memory 1503 may also include a non-volatile memory, for example, a read-only memory (ROM), a flash memory, a hard disk drive (HDD), or a solid-state drive (SSD). The memory 1503 may further include a combination of the foregoing types of memories.

The processor 1502 and the memory 1503 may be coupled through an interface, or may be integrated together. This is not limited in this embodiment.

The transceiver 1501 and the processor 1502 may be configured to implement the radio channel data processing method in the embodiment shown in FIG. 8. Specific implementations are as follows:

The processor 1502 is configured to determine, based on source distribution information, a modulation and coding scheme used by the second communication device.

The transceiver 1501 is configured to send control information to the first communication device. The control information includes source distribution information and a modulation and coding scheme.

The transceiver 1501 is further configured to send a data stream to the first communication device. The data stream is obtained by the second communication device by performing modulation and coding on an information bit based on the modulation and coding scheme.

In an embodiment, the processor 1502 is further configured to:
obtain a plurality of source distribution quantization intervals; and
determine, for one source distribution quantization interval in the plurality of source distribution quantization intervals, a channel state quantization interval and a modulation and coding scheme corresponding to the source distribution quantization interval, where the source distribution quantization interval corresponds to one or more channel state quantization intervals, the source distribution quantization interval corresponds to one or more modulation and coding schemes, and one channel state quantization interval corresponds to one modulation and coding scheme.

In an embodiment, that the processor 1502 is configured to determine, based on source distribution information, a modulation and coding scheme used by the second communication device is specifically configured to:
determine a corresponding source distribution quantization interval based on a source distribution probability or a source entropy;
determine a corresponding channel state quantization interval based on a preset signal-to-noise ratio working point; and
determine a corresponding channel coding matrix and modulation order based on the corresponding source distribution quantization interval and the corresponding channel state quantization interval.

In an embodiment, that the processor 1502 is configured to determine, based on source distribution information, a modulation and coding scheme used by the second communication device is specifically configured to:
determine a corresponding channel coding matrix, modulation order, and first code rate based on a source distribution probability or a source entropy and a preset quantity of resources, where the first code rate is a code rate of the channel coding matrix.

In an embodiment, that the processor 1502 is configured to determine a corresponding channel coding matrix, modulation order, and first code rate based on a source distribution probability or a source entropy and a preset quantity of resources is specifically configured to:
determine the modulation order based on a preset signal-to-noise ratio working point;
determine a rate-compatible coding matrix set based on the source distribution probability or the source entropy, where the rate-compatible coding matrix set includes one or more coding matrices, and one coding matrix corresponds to one code rate;
determine the first code rate based on the preset quantity of resources, the modulation order, and a source bit rate; and
determine, from the rate-compatible coding matrix set based on the first code rate, a coding matrix corresponding to the first code rate as the channel coding matrix.

In an embodiment, that the processor 1502 is configured to determine a corresponding channel coding matrix, modulation order, and first code rate based on a source distribution probability or a source entropy and a preset quantity of resources is specifically configured to:
determine a rate-compatible coding matrix set based on the source distribution probability or the source entropy, where the rate-compatible coding matrix set includes one or more coding matrices, and one coding matrix corresponds to one code rate;
determine a first relationship that is satisfied between the preset quantity of resources, the modulation order, the first code rate, and a source bit rate, where the first code rate is the code rate of the channel coding matrix;
determine a second relationship that is satisfied between the first code rate and a second code rate, where the second code rate is a maximum code rate of a coding matrix indicated by the source distribution information;
determine the modulation order based on the first relationship and the second relationship;
determine the first code rate based on the modulation order and the first relationship; and
determine, from the rate-compatible coding matrix set, a corresponding coding matrix as the corresponding channel coding matrix based on the first code rate.

In an embodiment, the transceiver 1501 is further configured to send first feedback information to the first communication device. The first feedback information includes a signal-to-noise ratio of a channel used by the first communication device to send the data stream to the second communication device.

In an embodiment, the transceiver 1501 is further configured to send second feedback information to the first communication device. The second feedback information indicates correct decoding of the second communication device.

An embodiment of this application provides a communication apparatus. As shown in FIG. 16, the communication apparatus is configured to implement the method performed by a first communication device in the embodiment shown in FIG. 8, and specifically includes a transceiver unit 1601 and a processing unit 1602.

The transceiver unit 1601 is configured to receive control information from a second communication device. The control information includes source distribution information and a modulation and coding scheme, and the modulation and coding scheme is determined based on the source distribution information.

The transceiver unit 1601 is further configured to receive a data stream from the second communication device. The data stream is obtained by the second communication device by performing modulation and coding on an information bit based on the modulation and coding scheme.

The processing unit 1602 is configured to perform demodulation and decoding on the data stream based on the control information.

In an embodiment, that the processing unit 1602 is configured to perform demodulation and decoding on the data stream based on the control information is specifically configured to:
demodulate the data stream based on a modulation order indicated by the modulation and coding scheme; and
obtain the information bit through decoding based on the source distribution information and a channel coding matrix indicated by the modulation and coding scheme.

In an embodiment, that the processing unit 1602 is configured to demodulate the data stream based on a modulation order indicated by the modulation and coding scheme is specifically configured to:
obtain first information bit soft information and parity bit soft information in the data stream through demodulating.

That the processing unit 1602 is configured to obtain, through decoding based on the source distribution information and a channel coding matrix indicated by the modulation and coding scheme, the information bit included in the demodulated data stream is specifically configured to:
determine second information bit soft information based on the source distribution information; and
obtain the information bit through decoding based on the second information bit soft information and the parity bit soft information.

In an embodiment, the transceiver unit 1601 is further configured to send first feedback information to the second communication device. The first feedback information includes a signal-to-noise ratio of a channel used by the second communication device to send the data stream to the first communication device.

In an embodiment, the transceiver unit 1601 is further configured to send second feedback information to the second communication device. The second feedback information indicates correct decoding of the first communication device.

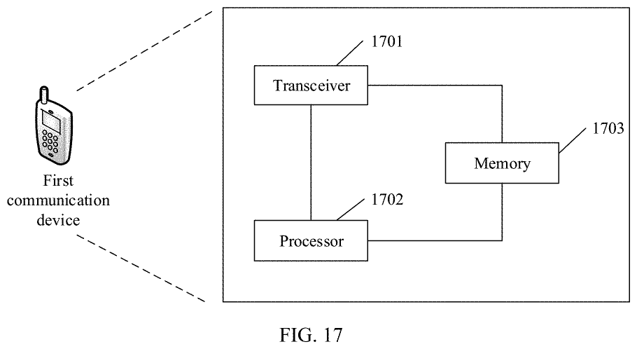

In an embodiment, related functions implemented by the units in FIG. 16 may be implemented by using a transceiver and a processor. FIG. 17 is a schematic diagram of a structure of another first communication device according to an embodiment of this application. The first communication device may be a device (for example, a chip) that has a radio channel data processing function in the embodiment shown in FIG. 8. The first communication device may include a transceiver 1701, at least one processor 1702, and a memory 1703. The transceiver 1701, the processor 1702, and the memory 1703 may be connected to each other through one or more communication buses, or may be connected to each other in another manner.

The transceiver 1701 may be configured to send data or receive data. It may be understood that the transceiver 1701 is a general term, and may include a receiver and a transmitter. For example, the receiver is configured to receive control information from a second communication device.

The processor 1702 may be configured to process data of the first communication device, or process data to be sent by the transceiver 1701. The processor 1702 may include one or more processors. For example, the processor 1702 may be one or more central processing units (CPU), one or more network processors (NP), one or more hardware chips, or any combination thereof. When the processor 1702 is one CPU, the CPU may be a single-core CPU or may be a multi-core CPU.

The memory 1703 is configured to store program code and the like. The memory 1703 may include a volatile memory, for example, a random access memory (RAM). The memory 1703 may also include a non-volatile memory, for example, a read-only memory (ROM), a flash memory, a hard disk drive (HDD), or a solid-state drive (SSD). The memory 1703 may further include a combination of the foregoing types of memories.

The processor 1702 and the memory 1703 may be coupled through an interface, or may be integrated together. This is not limited in this embodiment.

The transceiver 1701 and the processor 1702 may be used in the radio channel data processing method in the embodiment shown in FIG. 8. Specific implementations are as follows:

The transceiver 1701 is configured to receive control information from the second communication device. The control information includes source distribution information and a modulation and coding scheme, and the modulation and coding scheme is determined based on the source distribution information.

The transceiver 1701 is further configured to receive a data stream from the second communication device. The data stream is obtained by the second communication device by performing modulation and coding on an information bit based on the modulation and coding scheme.

The processor 1702 is configured to perform demodulation and decoding on the data stream based on the control information.

In an embodiment, that the processor 1702 is configured to perform demodulation and decoding on the data stream based on the control information is specifically configured to:
demodulate the data stream based on a modulation order indicated by the modulation and coding scheme; and
obtain the information bit through decoding based on the source distribution information and a channel coding matrix indicated by the modulation and coding scheme.

In an embodiment, that the processor 1702 is configured to demodulate the data stream based on a modulation order indicated by the modulation and coding scheme is specifically configured to:
obtain first information bit soft information and parity bit soft information in the data stream through demodulating.

That the processor 1702 is configured to obtain, through decoding based on the source distribution information and a channel coding matrix indicated by the modulation and coding scheme, the information bit included in the demodulated data stream is specifically configured to:
determine second information bit soft information based on the source distribution information; and
obtain the information bit through decoding based on the second information bit soft information and the parity bit soft information.

In an embodiment, the transceiver 1701 is further configured to send first feedback information to the second communication device. The first feedback information includes a signal-to-noise ratio of a channel used by the second communication device to send the data stream to the first communication device.

In an embodiment, the transceiver 1701 is further configured to send second feedback information to the second communication device. The second feedback information indicates correct decoding of the first communication device.

An embodiment of this application provides a communication apparatus. The communication apparatus includes an input interface, an output interface, and a logic circuit. The output interface is configured to output processed data. The input interface is configured to input to-be-processed data. The logic circuit processes the to-be-processed data by using the method in the embodiment shown in FIG. 6, to obtain the processed data.

In an embodiment, the processed data output by the output interface includes the uplink resource request message in the embodiment shown in FIG. 6, and the to-be-processed data input by the input interface includes the uplink resource allocation message in the embodiment shown in FIG. 6.

In an embodiment, that the logic circuit processes the to-be-processed data by using the method in the embodiment shown in FIG. 6, to obtain the processed data specifically includes:

The logic circuit performs, based on a second modulation and coding scheme, modulation and coding on an information bit by using the method in the embodiment shown in FIG. 6.

In an embodiment, the processed data output by the output interface includes the data stream in the embodiment shown in FIG. 6. The data stream is determined by a first communication device by performing modulation and coding on the information bit based on the second modulation and coding scheme.

In an embodiment, the to-be-processed data input by the input interface includes the uplink resource request message in the embodiment shown in FIG. 6, and the processed data output by the output interface includes the uplink resource allocation message in the embodiment shown in FIG. 6.

In an embodiment, that the logic circuit processes the to-be-processed data by using the method in the embodiment shown in FIG. 6, to obtain the processed data specifically includes:

The logic circuit allocates the second modulation and coding scheme to the first communication device by using the method in the embodiment shown in FIG. 6.

In an embodiment, the processed data output by the output interface includes the decoded data in the embodiment shown in FIG. 6. The decoded data may be an information bit obtained by demodulating and decoding the data stream based on the second modulation and coding scheme and source distribution information.

An embodiment of this application provides a communication apparatus. The communication apparatus includes an input interface, an output interface, and a logic circuit. The output interface is configured to output processed data. The input interface is configured to input to-be-processed data. The logic circuit processes the to-be-processed data by using the method in the embodiment shown in FIG. 6, to obtain the processed data.

In an embodiment, the processed data output by the output interface includes the control information in the embodiment shown in FIG. 8, and the to-be-processed data input by the input interface includes the source distribution information in the embodiment shown in FIG. 8.

In an embodiment, that the logic circuit processes the to-be-processed data by using the method in the embodiment shown in FIG. 8, to obtain the processed data specifically includes:

The logic circuit determines, by using the method in the embodiment shown in FIG. 8 based on the source distribution information, a modulation and coding scheme used by a second communication device.

In an embodiment, the processed data output by the output interface includes the data stream in the embodiment shown in FIG. 8. The data stream is determined by the second communication device by performing modulation and coding on an information bit based on the modulation and coding scheme.

In an embodiment, the to-be-processed data input by the input interface includes the control information and the data stream in the embodiment shown in FIG. 8.

In an embodiment, that the logic circuit processes the to-be-processed data by using the method in the embodiment shown in FIG. 8, to obtain the processed data specifically includes:

The logic circuit performs, based on the control information, demodulation and decoding on the data stream by using the method in the embodiment shown in FIG. 8.

An embodiment of this application provides a communication system. The communication system includes the first communication device and the second communication device in the foregoing embodiments.

An embodiment of this application provides a computer-readable storage medium. The computer-readable storage medium stores a program or instructions. When the program or the instructions are run on a computer, the computer is enabled to perform the data processing method in embodiments of this application.

An embodiment of this application provides a chip or a chip system. The chip or the chip system includes at least one processor and an interface, the interface is interconnected to the at least one processor through a line, and the at least one processor is configured to run a computer program or instructions, to perform the data processing method in embodiments of this application.

The interface in the chip may be an input/output interface, a pin, a circuit, or the like.

The chip system in the foregoing aspects may be a system on chip (SOC), a baseband chip, or the like. The baseband chip may include a processor, a channel encoder, a digital signal processor, a modem, an interface module, and the like.

In an embodiment, the chip or the chip system described in this application further includes at least one memory, and the at least one memory stores instructions. The memory may be a storage unit inside the chip, for example, a register or a cache, or may be a storage unit (for example, a read-only memory or a random access memory) of the chip.

All or some of the foregoing embodiments may be implemented by software, hardware, firmware, or any combination thereof. When the software is used for implementation, all or some of the embodiments may be implemented in a form of a computer program product. The computer program product includes one or more computer instructions. When the computer instructions are loaded and executed on the computer, the procedure or functions according to embodiments of this application are all or partially generated. The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk drive, or a magnetic tape), an optical medium (for example, a high-density digital video disc (DVD)), a semiconductor medium (for example, a solid-state drive (SSD)), or the like.

A person of ordinary skill in the art may be aware that, in combination with the examples described in embodiments disclosed in this specification, units and algorithm steps can be implemented by electronic hardware, computer software, or a combination thereof. To clearly describe the interchangeability between the hardware and the software, the foregoing has generally described compositions and steps of each example based on functions. Whether the functions are performed by hardware or software depends on particular applications and design constraints of technical solutions. A person skilled in the art may use different methods to implement the described functions for each particular application, but it should not be considered that the implementation goes beyond the scope of this application.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A radio channel data processing method, applied in a first communication device, wherein the method comprises:
sending an uplink resource request message to a second communication device, wherein the uplink resource request message comprises source distribution information and a first modulation and coding scheme, and the first modulation and coding scheme is determined based on the source distribution information;
receiving an uplink resource allocation message from the second communication device, wherein the uplink resource allocation message comprises a second modulation and coding scheme, and the second modulation and coding scheme is a modulation and coding scheme allocated by the second communication device to the first communication device; and
performing modulation and coding on an information bit based on the second modulation and coding scheme.

2. The method according to claim 1, wherein before the sending an uplink resource request message to a second communication device, the method further comprises:
obtaining a plurality of source distribution quantization intervals; and
determining, for one source distribution quantization interval in the plurality of source distribution quantization intervals, a channel state quantization interval and a modulation and coding scheme corresponding to the source distribution quantization interval, wherein the source distribution quantization interval corresponds to one or more channel state quantization intervals, the source distribution quantization interval corresponds to one or more modulation and coding schemes, and one of the channel state quantization intervals corresponds to one of the modulation and coding schemes.

3. The method according to claim 2, wherein that the first modulation and coding scheme is determined based on the source distribution information comprises:
determining a corresponding source distribution quantization interval based on a source distribution probability or a source entropy;
determining a corresponding channel state quantization interval based on a preset signal-to-noise ratio working point; and
determining a corresponding channel coding matrix and modulation order based on the corresponding source distribution quantization interval and the corresponding channel state quantization interval.

4. The method according to claim 1, wherein that a modulation and coding scheme requested by the first communication device is determined based on the source distribution information comprises:
determining a corresponding channel coding matrix, a modulation order, and first code rate based on a source distribution probability or a source entropy and a preset quantity of resources, wherein the first code rate is a code rate of the corresponding channel coding matrix.

5. The method according to claim 4, wherein the determining a corresponding channel coding matrix, a modulation order, and first code rate based on a source distribution probability or a source entropy and a preset quantity of resources comprises:
determining the modulation order based on a preset signal-to-noise ratio working point;
determining a rate-compatible coding matrix set based on the source distribution probability or the source entropy, wherein the rate-compatible coding matrix set comprises one or more coding matrices, and one coding matrix corresponds to one code rate;
determining the first code rate based on the preset quantity of resources, the modulation order, and a source bit rate; and
determining, from the rate-compatible coding matrix set based on the first code rate, a coding matrix corresponding to the first code rate as the corresponding channel coding matrix.

6. The method according to claim 4, wherein the determining a corresponding channel coding matrix, a modulation order, and first code rate based on a source distribution probability or a source entropy and a preset quantity of resources comprises:
determining a rate-compatible coding matrix set based on the source distribution probability or the source entropy, wherein the rate-compatible coding matrix set comprises one or more coding matrices, and one coding matrix corresponds to one code rate;
determining a first relationship that is satisfied between the preset quantity of resources, the modulation order, the first code rate, and a source bit rate, wherein the first code rate is the code rate of the channel coding matrix;
determining a second relationship that is satisfied between the first code rate and a second code rate, wherein the second code rate is a maximum code rate of a coding matrix indicated by the source distribution information;
determining the modulation order based on the first relationship and the second relationship;
determining the first code rate based on the modulation order and the first relationship; and
determining, from the rate-compatible coding matrix set, a corresponding coding matrix as the corresponding channel coding matrix based on the first code rate.

7. A radio channel data processing method, applied in a second communication device, wherein the method comprises:
receiving an uplink resource request message from a first communication device, wherein the uplink resource request message comprises source distribution information and a first modulation and coding scheme, and the first modulation and coding scheme is determined based on the source distribution information; and
sending an uplink resource allocation message to the first communication device, wherein the uplink resource allocation message comprises a second modulation and coding scheme, and the second modulation and coding scheme is a modulation and coding scheme allocated by the second communication device to the first communication device.

8. The method according to claim 7, wherein the method further comprises:
receiving a data stream from the first communication device, wherein the data stream is determined by the first communication device by performing modulation and coding on an information bit based on the second modulation and coding scheme; and
performing demodulation and decoding on the data stream based on the second modulation and coding scheme and the source distribution information.

9. The method according to claim 8, wherein the performing demodulation and decoding on the data stream based on the second modulation and coding scheme and the source distribution information comprises:
demodulating the data stream based on a modulation order indicated by the second modulation and coding scheme; and
obtaining the information bit through decoding based on the source distribution information and a channel coding matrix indicated by the second modulation and coding scheme.

10. The method according to claim 9, wherein the demodulating the data stream based on a modulation order indicated by the second modulation and coding scheme comprises:
obtaining first information bit soft information and parity bit soft information in the data stream through demodulating; and
the obtaining, through decoding based on the source distribution information and a channel coding matrix indicated by the second modulation and coding scheme, the information bit comprised in the demodulated data stream comprises:
determining second information bit soft information based on the source distribution information; and
obtaining the information bit through decoding based on the second information bit soft information and the parity bit soft information.

11. A radio channel data processing method, applied in a second communication device, wherein the method comprises:
determining, based on source distribution information, a modulation and coding scheme used by the second communication device, wherein the modulation and coding scheme indicates a channel coding matrix and a modulation order that are used by the second communication device to perform modulation and coding on an information bit;
sending control information to a first communication device, wherein the control information comprises the source distribution information and the modulation and coding scheme; and
sending a data stream to the first communication device, wherein the data stream is obtained by the second communication device by performing modulation and coding on the information bit based on the modulation and coding scheme.

12. The method according to claim 11, wherein before the determining, based on source distribution information, a modulation and coding scheme used by the second communication device, the method further comprises:
obtaining a plurality of source distribution quantization intervals;
determining, for one source distribution quantization interval in the plurality of source distribution quantization intervals, a channel state quantization interval and modulation and coding scheme corresponding to the source distribution quantization interval, wherein the source distribution quantization interval corresponds to one or more channel state quantization intervals, the source distribution quantization interval corresponds to one or more modulation and coding schemes, and one of the channel state quantization intervals corresponds to one of the modulation and coding schemes.

13. The method according to claim 12, wherein the determining, based on source distribution information, a modulation and coding scheme used by the second communication device comprises:
determining a corresponding source distribution quantization interval based on a source distribution probability or a source entropy;
determining a corresponding channel state quantization interval based on a preset signal-to-noise ratio working point; and
determining the corresponding channel coding matrix and a modulation order based on the corresponding source distribution quantization interval and the corresponding channel state quantization interval.

14. The method according to claim 11, wherein the determining, based on source distribution information, a modulation and coding scheme used by the second communication device comprises:
determining the corresponding channel coding matrix and a modulation order and a corresponding first code rate based on a source distribution probability or a source entropy and a preset quantity of resources, wherein the first code rate is a code rate of the channel coding matrix.

15. The method according to claim 14, wherein the determining the corresponding channel coding matrix and a modulation order and a corresponding first code rate based on a source distribution probability or a source entropy and a preset quantity of resources comprises:
determining the modulation order based on a preset signal-to-noise ratio working point;
determining a rate-compatible coding matrix set based on the source distribution probability or the source entropy, wherein the rate-compatible coding matrix set comprises one or more coding matrices, and one coding matrix corresponds to one code rate;
determining the first code rate based on the preset quantity of resources, the modulation order, and a source bit rate; and
determining, from the rate-compatible coding matrix set based on the first code rate, a coding matrix corresponding to the first code rate as the channel coding matrix.

16. The method according to claim 14, wherein the determining the corresponding channel coding matrix and a modulation order and a corresponding first code rate based on a source distribution probability or a source entropy and a preset quantity of resources comprises:
determining a rate-compatible coding matrix set based on the source distribution probability or the source entropy, wherein the rate-compatible coding matrix set comprises one or more coding matrices, and one coding matrix corresponds to one code rate;
determining a first relationship that is satisfied between the preset quantity of resources, the modulation order, the first code rate, and a source bit rate, wherein the first code rate is the code rate of the channel coding matrix;
determining a second relationship that is satisfied between the first code rate and a second code rate, wherein the second code rate is a maximum code rate of a coding matrix indicated by the source distribution information;
determining the modulation order based on the first relationship and the second relationship;
determining the first code rate based on the modulation order and the first relationship; and
determining, from the rate-compatible coding matrix set, a corresponding coding matrix as the corresponding channel coding matrix based on the first code rate.
